(19) United States
(12) Patent Application Publication
(10) Pub. No.: US 2021/0367356 A1
(43) Pub. Date: Nov. 25, 2021

(54) ANTENNA DEVICE

(71) Applicant: MITSUBISHI ELECTRIC CORPORATION, Tokyo (JP)

(72) Inventors: Kengo NISHIMOTO, Tokyo (JP); Yasuhiro NISHIOKA, Tokyo (JP)

(73) Assignee: MITSUBISHI ELECTRIC CORPORATION, Tokyo (JP)

(21) Appl. No.: 17/387,434

(22) Filed: Jul. 28, 2021

Related U.S. Application Data
(63) Continuation of application No. PCT/JP2019/008087, filed on Mar. 1, 2019.

(51) Int. Cl. H01Q 21/28; H01Q 1/52; H01Q 1/50; H04B 1/401

(52) U.S. Cl. CPC H01Q 21/28; H04B 1/401; H01Q 1/50; H01Q 1/52

(57) ABSTRACT

The antenna device includes a first radiation element, a second radiation element, a first input and output terminal, a second input and output terminal, a first phase shifter, a first susceptance element, a second susceptance element, a third susceptance element, a fourth susceptance element, a first variable matching circuit, and a second variable matching circuit, and when power is supplied from the first input and output terminal or the second input and output terminal, each susceptance value of the first susceptance element, the second susceptance element, the third susceptance element, and the fourth susceptance element are set so that an excitation amplitude of the first radiation element and an excitation amplitude of the second radiation element have a substantially equal amplitude, and coupling between the first input and output terminal and the second input and output terminal is reduced.

### CROSS REFERENCE TO RELATED APPLICATIONS

This application is a Continuation of PCT International Application No. PCT/JP2019/008087, filed on Mar. 1, 2019, which is hereby expressly incorporated by reference into the present application.

### TECHNICAL FIELD

The present invention relates to an antenna device.

### BACKGROUND ART

In a wireless communication device having an antenna device, it is effective to provide the antenna device with a diversity function in order to prevent deterioration of communication quality due to multipath fading or the like. The diversity function can reduce the decrease in received power due to fading as the number of branches increases. In the diversity function, it is generally necessary to increase the number of radiation elements in order to increase the number of branches, and N radiation elements are required to form N branches (N is a natural number of two or more).

However, for example, when a small wireless communication device includes a plurality of radiation elements, the mutual coupling between the radiation elements is strong and thereby the correlation between the radiation elements or branches is high, so that it is difficult for the small wireless communication device to include a large number of radiation elements.

In order to solve this problem, for example, Patent Literature 1 discloses a circularly polarized wave switching type antenna that emits a right-handed circularly polarized wave or left-handed circularly polarized wave. The circularly polarized wave switching type antenna described in Patent Literature 1 includes a radiation element (hereinafter referred to as “configuration A”) that has two feeding points and emits a circularly polarized wave, a first phase shifter (hereinafter referred to as “configuration B”) that has one end connected to one feeding point in the radiation element and shifts a phase of a signal by 0 degrees or 180 degrees, a second phase shifter that has one end connected to the other feeding point in the radiation element and shifts a phase of a signal by 0 degrees or 180 degrees, and a 90-degree hybrid circuit that divides an input signal into two signals with a phase difference of 90 degrees, outputs one of the divided signals to the first phase shifter, and outputs the other divided signal to the second phase shifter.

### CITATION LIST

### Patent Literature

Patent Literature 1: JP 2000-223942 A

### SUMMARY OF INVENTION

### Technical Problem

As an example, an antenna device in which the configuration A and the configuration B are deleted from the circularly polarized wave switching type antenna described in Patent Literature 1 and a first radiation element and a second radiation element are further added is assumed. In the assumed antenna device, the first radiation element is connected to the first output terminal of the 90-degree hybrid circuit, and the second radiation element is connected to the second output terminal of the 90-degree hybrid circuit via the second phase shifter. The assumed antenna device can implement a 4-branch diversity function using two radiation elements, the first radiation element and the second radiation element, by switching the phase shift amount of the second phase shifter by a control signal or the like.

However, in the assumed antenna device, when the distance between the first radiation element and the second radiation element is narrow, especially when the distance between the first radiation element and the second radiation element is equal to or less than half the wavelength of the operating frequency, mutual coupling between the first radiation element and the second radiation element is strong. In the antenna device, when the mutual coupling between the first radiation element and the second radiation element is strong, for example, most of the signals emitted from the first radiation element are incident on the second radiation element, so the reflection amplitude of the signal is large at the input terminal of the 90-degree hybrid circuit, and the signal cannot be emitted efficiently.

The present invention is made to solve the above-mentioned problems, and has an object to provide an antenna device which can reduce a signal loss even when the distance between the two radiation elements is narrow while implementing a 4-branch diversity function with two radiation elements.

### Solution to Problem

The antenna device according to the present invention includes a first radiation element, a second radiation element, a first input and output terminal, a second input and output terminal, a first phase shifter having a first end connected to the second radiation element, a first susceptance element having a first end connected to the first radiation element and a second end connected to a second end of the first phase shifter, a second susceptance element having a first end connected to a first end of the first susceptance element, a third susceptance element having a first end connected to a second end of the first susceptance element, a fourth susceptance element having a first end connected to a second end of the second susceptance element and a second end connected to a second end of the third susceptance element, a first variable matching circuit having a first end connected to a first end of the fourth susceptance element and a second end connected to the first input and output terminal, and a second variable matching circuit having a first end connected to a second end of the fourth susceptance element and a second end connected to the second input and output terminal, in which when power is supplied from the first input and output terminal or the second input and output terminal, each susceptance value of the first susceptance element, the second susceptance element, the third susceptance element, and the fourth susceptance element are set so that an excitation amplitude of the first radiation element and an excitation amplitude of the second radiation element have a substantially equal amplitude, and coupling between the first input and output terminal and the second input and output terminal is reduced.

### Advantageous Effects of Invention

According to the present invention, it is possible to reduce a signal loss even when the distance between two radiation elements is narrow while implementing a 4-branch diversity function with two radiation elements.

### BRIEF DESCRIPTION OF DRAWINGS

FIG. 1 is a diagram showing an example of a configuration of a main part of an antenna device according to a first embodiment.

FIG. 2 is a diagram illustrating an operating mechanism of the antenna device according to the first embodiment.

FIG. 3 is a diagram showing an example of a configuration of a radiation element of the antenna device according to the first embodiment.

FIG. 4 is a diagram showing an S-parameter calculation result in an antenna device composed of only the radiation element shown in FIG. 3.

FIG. 5A is a diagram showing an S-parameter calculation result when a first phase shifter is in mode 1 when the configuration shown in FIG. 3 is applied to the radiation element of the antenna device according to the first embodiment. FIG. 5B is a diagram showing an S-parameter calculation result when the first phase shifter is in mode 2 when the configuration shown in FIG. 3 is applied to the radiation element of the antenna device according to the first embodiment.

FIG. 6 is a diagram showing a radiation pattern calculation result when the configuration shown in FIG. 3 is applied to the radiation element of the antenna device according to the first embodiment.

FIG. 7 is a diagram showing a calculation result of a correlation coefficient between each branch when the configuration shown in FIG. 3 is applied to the radiation element of the antenna device according to the first embodiment.

FIG. 8A is a diagram showing an example of a configuration of a main part of an antenna device according to a second embodiment. FIG. 8B is a diagram showing states of a first DPDT switch, a second DPDT switch, and a third DPDT switch when the first phase shifter is in mode 1 in the antenna device according to the second embodiment. FIG. 8C is a diagram showing the states of the first DPDT switch, the second DPDT switch, and the third DPDT switch when the first phase shifter is in mode 2 in the antenna device according to the second embodiment.

FIG. 9 is a diagram showing an example of a configuration of a main part of an antenna device according to a third embodiment.

FIG. 10 is a diagram illustrating an operating mechanism of the antenna device according to the third embodiment.

FIG. 11A is a diagram showing an example of a configuration of a main part of an antenna device according to a fourth embodiment. FIG. 11B is a diagram showing states of a fourth DPDT switch and a fifth DPDT switch when a second phase shifter and a third phase shifter are in mode 3 in the antenna device according to the fourth embodiment. FIG. 11C is a diagram showing the states of the fourth DPDT switch and the fifth DPDT switch when the second phase shifter and the third phase shifter are in mode 4 in the antenna device according to the fourth embodiment.

FIG. 12A is a diagram showing an example of a configuration of a main part of an antenna device according to a fifth embodiment. FIG. 12B is a diagram showing states of a sixth DPDT switch and a seventh DPDT switch when the second phase shifter and the third phase shifter are in mode 3 in the antenna device according to the fifth embodiment. FIG. 12C is a diagram showing the states of the sixth DPDT switch and the seventh DPDT switch when the second phase shifter and the third phase shifter are in mode 4 in the antenna device according to the fifth embodiment.

FIG. 13 is a diagram showing an example of a configuration of a transmission line.

### DESCRIPTION OF EMBODIMENTS

Hereinafter, embodiments of the present invention will be described in detail with reference to the drawings.

### First Embodiment

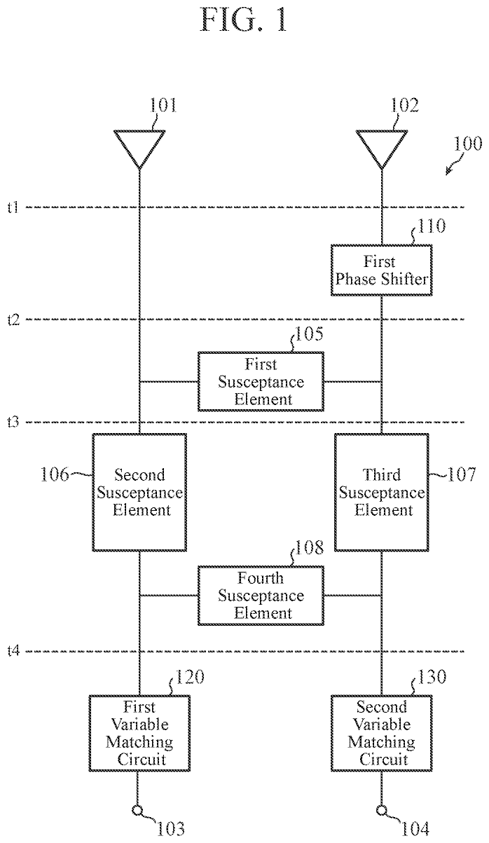

An antenna device 100 according to a first embodiment will be described with reference to FIGS. 1 to 7.

An example of the configuration of the main part of the antenna device 100 according to the first embodiment will be described with reference to FIG. 1.

The antenna device 100 according to the first embodiment includes a first radiation element 101, a second radiation element 102, a first input and output terminal 103, a second input and output terminal 104, a first phase shifter 110, a first susceptance element 105, a second susceptance element 106, a third susceptance element 107, a fourth susceptance element 108, a first variable matching circuit 120, and a second variable matching circuit 130.

One end of the first phase shifter 110 is connected to the second radiation element 102.

One end of the first susceptance element 105 is connected to the first radiation element 101.

The other end of the first susceptance element 105 is connected to the other end of the first phase shifter 110.

One end of the second susceptance element 106 is connected to one end of the first susceptance element 105.

One end of the third susceptance element 107 is connected to the other end of the first susceptance element 105.

One end of the fourth susceptance element 108 is connected to the other end of the second susceptance element 106.

The other end of the fourth susceptance element 108 is connected to the other end of the third susceptance element 107.

One end of the first variable matching circuit 120 is connected to one end of the fourth susceptance element 108.

The other end of the first variable matching circuit 120 is connected to the first input and output terminal 103.

One end of the second variable matching circuit 130 is connected to the other end of the fourth susceptance element 108.

The other end of the second variable matching circuit 130 is connected to the second input and output terminal 104.

In the antenna device 100, it is assumed that the reflection amplitudes of the first radiation element 101 and the second radiation element 102 on a reference plane t1 shown in FIG. 1 are sufficiently low due to the configuration or shape of the first radiation element 101 and the second radiation element 102. In the antenna device 100, when the reflection amplitudes of the first radiation element 101 and the second radiation element 102 on the reference plane t1 cannot be sufficiently reduced due to the configuration or shape of the first radiation element 101 and the second radiation element 102, they may be reduced by using a matching circuit or the like.

The first phase shifter 110 shifts the phase of the signal input to the first phase shifter 110.

Specifically, the first phase shifter 110 has two states that are a state of shifting the phase of a signal input to the first phase shifter 110 by 0 degrees as a phase shift amount, and a state of shifting the phase of the signal input to the first phase shifter 110 by +90 degrees as a phase shift amount. The state of the first phase shifter 110 is switched to either state of the two states by, for example, a control signal received from the outside of the device.

Note that the 0 degree referred to here is not limited to strict 0 degrees, but includes substantially 0 degrees. Hereinafter, 0 degrees will be described as including substantially 0 degrees. In addition, the +90 degrees referred to here are not limited to strict +90 degrees, but includes substantially +90 degrees. Hereinafter, +90 degrees will be described as including substantially +90 degrees.

The first variable matching circuit 120 and the second variable matching circuit 130 reduce the reflection amplitudes at the first input and output terminal 103 and the second input and output terminal 104 by matching the impedance in the antenna device 100.

Specifically, the first variable matching circuit 120 and the second variable matching circuit 130 match the impedance in the antenna device 100 according to the phase shift amount of the first phase shifter 110.

More specifically, the first variable matching circuit 120 has two states individually corresponding to the two states of the first phase shifter 110. The state of the first variable matching circuit 120, in synchronization with switching of the first phase shifter 110 to either state of the two states of the first phase shifter 110, is switched to a state corresponding to a state after the first phase shifter 110 is switched in the first variable matching circuit 120, for example, by the control signal received from the outside of the device.

Further, the second variable matching circuit 130 has two states individually corresponding to the two states of the first phase shifter 110. The state of the second variable matching circuit 130, in synchronization with switching of the first phase shifter 110 to either state of the two states of the first phase shifter 110, is switched to a state corresponding to a state after the first phase shifter 110 is switched in the second variable matching circuit 130, for example, by the control signal received from the outside of the device.

Each of the first susceptance element 105, the second susceptance element 106, the third susceptance element 107, and the fourth susceptance element 108 is an element composed of an inductor, a capacitor, a 0Ω resistor, or the like and having a susceptance value.

The antenna device 100 includes a decoupling circuit composed of the second susceptance element 106, the third susceptance element 107, and the fourth susceptance element 108.

When power is supplied from the first input and output terminal 103 or the second input and output terminal 104, the susceptance values of the first susceptance element 105, the second susceptance element 106, the third susceptance element 107, and the fourth susceptance element 108 are set so that the excitation amplitude of the first radiation element 101 and the excitation amplitude of the second radiation element 102 have a substantially equal amplitude, and the coupling between the first input and output terminal 103 and the second input and output terminal 104 is reduced.

More specifically, the first susceptance element 105 has a susceptance value B₁ set in advance. The antenna device 100 can change the excitation amplitude ratio between the first radiation element 101 and the second radiation element 102 by changing the susceptance value B₁ of the first susceptance element 105.

The susceptance value B₁ of the first susceptance element 105 is determined so as to satisfy Equation (1).

B₁=±1/Z₀ EQUATION (1)

where, Z₀ is a normalized impedance.

Further, an equal susceptance value B₂ is set in advance to the susceptance value of the second susceptance element 106 and the susceptance value of the third susceptance element 107. The fourth susceptance element 108 has a susceptance value B₃ set in advance.

The susceptance value B₂ of the second susceptance element 106 and the third susceptance element 107 and the susceptance value B₃ of the fourth susceptance element 108 are determined so as to satisfy all of Equations (2) to (6).

$$\begin{matrix} {Y}_{b} = ( \begin{matrix}{y}_{b 11} {y}_{b 12} \\ {y}_{b 21} {y}_{b 22}\end{matrix} ) = ( \begin{matrix}{{g}_{b}}_{11} + j {b}_{b 11} & {{g}_{b}}_{12} + j {b}_{b 12} \\ {g}_{b 21} + j {b}_{b 21} & {g}_{b 22} + j {b}_{b 22}\end{matrix} ) & EQUATION ( 2 ) \\ {B}_{2} = ( - {c}_{1} \pm \sqrt{{c}_{1}^{2} - 4 {g}_{b 12} {c}_{2}} ) / ( 2 {g}_{b 12} ) & EQUATION ( 3 ) \\ {B}_{3} = \frac{{B}_{2}^{2} {g}_{b 12}}{{b}_{b 11} {g}_{b 22} + {g}_{b 11} {b}_{b 22} - {g}_{b 12} {b}_{b 21} - {b}_{b 12} {g}_{b 21} + {B}_{2} ( {g}_{b 11} + {g}_{b 22} )} & EQUATION ( 4 ) \\ {c}_{1} = {g}_{b 12} ( {b}_{b 11} + {b}_{b 22} ) - {b}_{b 12} ( {g}_{b 11} + {g}_{b 22} ) & EQUATION ( 5 ) \\ {c}_{2} = - {g}_{b 12} ( {g}_{b 11} {g}_{b 22} - {b}_{b 11} {{b}_{b}}_{22} - {g}_{b 12} {g}_{b 21} ) + {b}_{b 12} ( - {b}_{b 11} {g}_{b 22} - {g}_{b 11} {b}_{b 22} + {b}_{b 12} {g}_{b 21} ) & EQUATION ( 6 )\end{matrix}$$

where, Y_{b} is an admittance matrix when the first radiation element 101 side and the second radiation element 102 side are viewed from one end of the second susceptance element 106 on the first radiation element 101 side and one end of the third susceptance element 107 on the second radiation element 102 side. That is, Y_{b} is an admittance matrix when the first radiation element 101 side and the second radiation element 102 side are viewed from a reference plane t3 shown in FIG. 1.

Moreover, the double sign corresponds to those of Equations (1) and (3) in the same order.

By setting the susceptance value determined as described above to the second susceptance element 106, the third susceptance element 107, and the fourth susceptance element 108, the decoupling circuit composed of the second susceptance element 106, the third susceptance element 107, and the fourth susceptance element 108 can reduce the mutual coupling when the first radiation element 101 side and the second radiation element 102 side are viewed from a reference plane t4.

In addition, when the phase of the mutual coupling when the first radiation element 101 side and the second radiation element 102 side are viewed from the reference plane t2 shown in FIG. 1 changes, the susceptance value B₂ and the susceptance value B₃, which can reduce the mutual coupling, usually change. However, by setting the susceptance value B₁ determined as in Equation (1) to the first susceptance element 105, the susceptance value B₂ and the susceptance value B₃, which can reduce the mutual coupling, do not change, even if the phase of the mutual coupling when the first radiation element 101 side and the second radiation element 102 side are viewed from the reference plane t2 shown in FIG. 1 changes. That is, by setting the susceptance value B₁ determined as in Equation (1) to the first susceptance element 105, the decoupling circuit can reduce the mutual coupling when the first radiation element 101 side and the second radiation element 102 side are viewed from the reference plane t3 without depending on the phase shift amount as which the first phase shifter 110 shifts the phase of the signal input to the first phase shifter 110.

Further, by setting the susceptance value B₁ determined as described above to the first susceptance element 105, the excitation amplitude of the first radiation element 101 and the excitation amplitude of the second radiation element 102 have an equal amplitude. The equal amplitude referred to here is not limited to a strict equal amplitude, and may include a substantially equal amplitude. Hereinafter, the equal amplitude will be described as including a substantially equal amplitude.

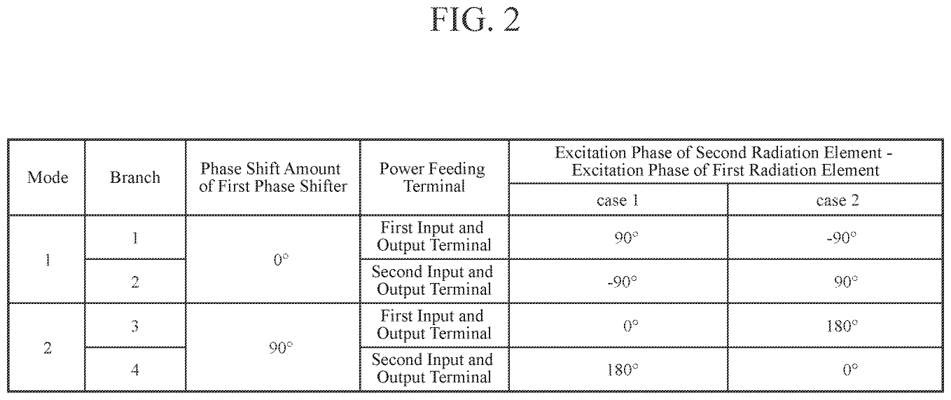

The operating mechanism of the antenna device 100 according to the first embodiment will be described with reference to FIG. 2.

Hereinafter, the case where the first phase shifter 110 is in a state (hereinafter referred to as “mode 1”) of shifting the phase of the signal input to the first phase shifter 110 by 0 degrees as the phase shift amount will be described.

The phase difference obtained by subtracting the excitation phase of the first radiation element 101 from the excitation phase of the second radiation element 102 is different between the case where power is supplied from the first input and output terminal 103 and the case where power is supplied from the second input and output terminal 104, due to the characteristics of the circuit composed of the first susceptance element 105, the second susceptance element 106, the third susceptance element 107, and the fourth susceptance element 108.

Specifically, when the susceptance value B₁ of the first susceptance element 105 is B₁=+1/Z₀ (hereinafter, referred to as “Case 1”), the phase difference obtained by subtracting the excitation phase of the first radiation element 101 from the excitation phase of the second radiation element 102 is +90 degrees when power is supplied from the first input and output terminal 103, and is −90 degrees when power is supplied from the second input and output terminal 104.

On the other hand, when the susceptance value B₁ of the first susceptance element 105 is B₁=−1/Z₀ (hereinafter, referred to as “Case 2”), the phase difference obtained by subtracting the excitation phase of the first radiation element 101 from the excitation phase of the second radiation element 102 is −90 degrees when power is supplied from the first input and output terminal 103, and is +90 degrees when power is supplied from the second input and output terminal 104.

Similarly, when the first phase shifter 110 is in a state of shifting the phase of the signal input to the first phase shifter 110 by +90 degrees as the phase shift amount (hereinafter referred to as “mode 2”), and when the susceptance value B₁ of the first susceptance element 105 is case 1, the phase difference obtained by subtracting the excitation phase of the first radiation element 101 from the excitation phase of the second radiation element 102 will be 0 degrees if power is supplied from the first input and output terminal 103, and will be +180 degrees if power is supplied from the second input and output terminal 104. Further, when the first phase shifter 110 is in mode 2, and when the susceptance value B₁ of the first susceptance element 105 is case 2, the phase difference obtained by subtracting the excitation phase of the first radiation element 101 from the excitation phase of the second radiation element 102 will be +180 degrees if power is supplied from the first input and output terminal 103, and will be 0 degrees if power is supplied from the second input and output terminal 104.

Hereinafter, a case where the susceptance value B₁ of the first susceptance element 105 is case 1 will be described.

When the first phase shifter 110 is in mode 1, and when power is supplied from the first input and output terminal 103, the antenna device 100 forms one branch (hereinafter referred to as “branch 1”) in which the phase difference obtained by subtracting the excitation phase of the first radiation element 101 from the excitation phase of the second radiation element 102 will be +90 degrees.

When the first phase shifter 110 is in mode 1, and when power is supplied from the second input and output terminal 104, the antenna device 100 forms one branch (hereinafter referred to as “branch 2”) in which the phase difference obtained by subtracting the excitation phase of the first radiation element 101 from the excitation phase of the second radiation element 102 will be −90 degrees.

When the first phase shifter 110 is in mode 2, and when power is supplied from the first input and output terminal 103, the antenna device 100 forms one branch (hereinafter referred to as “branch 3”) in which the phase difference obtained by subtracting the excitation phase of the first radiation element 101 from the excitation phase of the second radiation element 102 will be 0 degrees.

When the first phase shifter 110 is in mode 2, and when power is supplied from the second input and output terminal 104, the antenna device 100 forms one branch (hereinafter referred to as “branch 4”) in which the phase difference obtained by subtracting the excitation phase of the first radiation element 101 from the excitation phase of the second radiation element 102 will be +180 degrees.

In this way, in the antenna device 100, the first phase shifter 110 is switched to either mode 1 or mode 2, for example, by a control signal received from the outside of the device, power is controlled to be supplied from the first input and output terminal 103 or the second input and output terminal 104, and thereby it is possible to configure a 4-branch diversity function in which the phase difference obtained by subtracting the excitation phase of the first radiation element 101 from the excitation phase of the second radiation element 102 will be 0 degrees, +90 degrees, +180 degrees, or +270 degrees (−90 degrees).

In the antenna device 100, also when the susceptance value B₁ of the first susceptance element 105 is case 2, similarly to the case where the susceptance value B₁ of the first susceptance element 105 is case 1, the first phase shifter 110 is switched to either mode 1 or mode 2, for example, by a control signal received from the outside of the device, power is controlled to be supplied from the first input and output terminal 103 or the second input and output terminal 104, and thereby it is possible to configure a 4-branch diversity function in which the phase difference obtained by subtracting the excitation phase of the first radiation element 101 from the excitation phase of the second radiation element 102 will be 0 degrees, +90 degrees, +180 degrees, or +270 degrees (−90 degrees).

In the antenna device 100, since the phases of mutual coupling when the first radiation element 101 side and the second radiation element 102 side are viewed from the reference plane t2 shown in FIG. 1 are different between when the first phase shifter 110 is in mode 1 and when the first phase shifter 110 is in mode 2, the phases of reflection when the first radiation element 101 side and the second radiation element 102 side are viewed from the reference plane t4 shown in FIG. 1 are different. In the antenna device 100, by switching the states of the first variable matching circuit 120 and the second variable matching circuit 130 between when the first phase shifter 110 is in mode 1 and when the first phase shifter 110 is in mode 2, the reflection amplitudes at the first input and output terminal 103 and the second input and output terminal 104 are reduced. In the antenna device 100, since the decoupling circuit composed of the second susceptance element 106, the third susceptance element 107, and the fourth susceptance element 108 reduces the mutual coupling when the first radiation element 101 side and the second radiation element 102 side are viewed from the reference plane t4, the states of the first variable matching circuit 120 and the second variable matching circuit 130 can be switched independently.

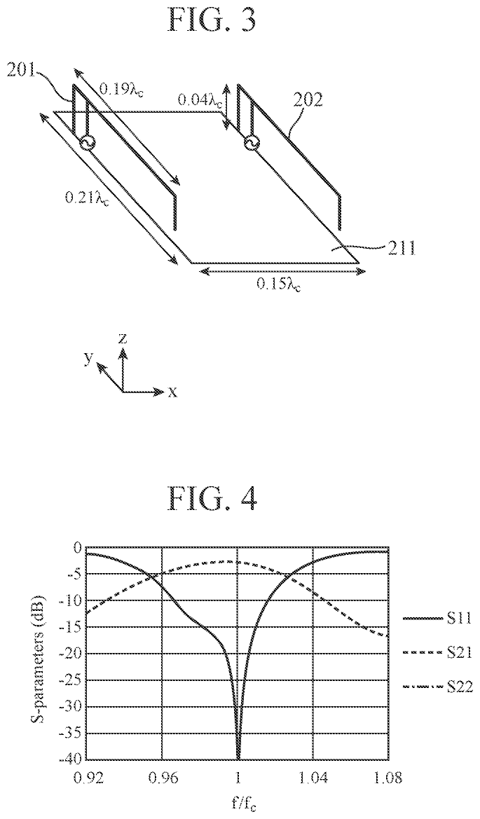

In order to confirm the effect of the antenna device 100 according to the first embodiment, the result of performing an electromagnetic field simulation using a two-element array antenna shown in FIG. 3 will be described with reference to FIGS. 3 to 5.

In FIG. 3, λc is a free space wavelength at a design frequency fc. In FIG. 3, two inverted-F antennas 201 and 202 are installed on a ground conductor plate 211, in which a length in the X direction shown in FIG. 3 is 0.15λc equal to or less than λc/2, and a length in the Y direction shown in FIG. 3 is 0.21λc, with an interval of 0.15λc.

Hereinafter, description will be provided assuming that the inverted-F antenna 201 is the first radiation element 101 and the inverted-F antenna 202 is the second radiation element 102.

FIG. 4 is a diagram showing an S-parameter calculation result in the antenna device composed of only the radiation elements shown in FIG. 3. That is, FIG. 4 shows an S-parameter calculation result when the two-element array antenna shown in FIG. 3 is applied to an antenna device in which the first phase shifter 110, the first susceptance element 105, the second susceptance element 106, the third susceptance element 107, the fourth susceptance element 108, the first variable matching circuit 120, and the second variable matching circuit 130 are removed from the antenna device 100 shown in FIG. 1, and the first radiation element 101 is connected to the first input and output terminal 103, and the second radiation element 102 is connected to the second input and output terminal 104.

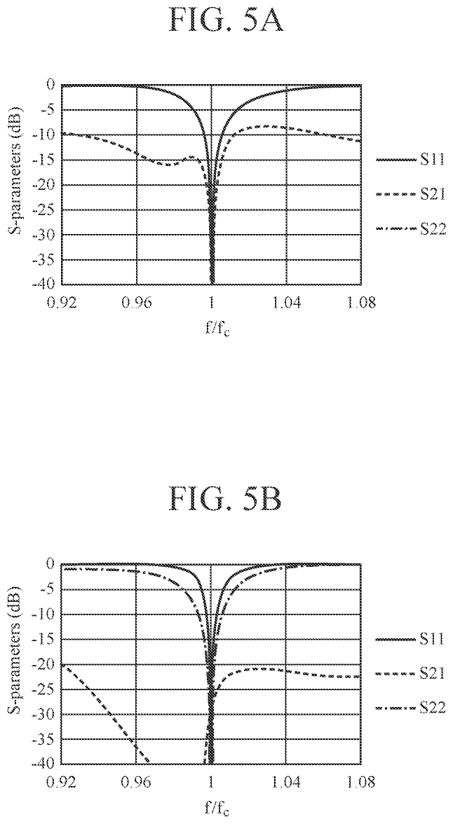

FIG. 5A is a diagram showing an S-parameter calculation result in a case where the first phase shifter 110 is in mode 1 when the configuration shown in FIG. 3 is applied to the first radiation element 101 and the second radiation element 102 of the antenna device 100 according to the first embodiment. FIG. 5B is a diagram showing an S-parameter calculation result in a case where the first phase shifter 110 is in mode 2 when the configuration shown in FIG. 3 is applied to the first radiation element 101 and the second radiation element 102 of the antenna device 100 according to the first embodiment.

In FIGS. 4 and 5, S11 indicates a reflection amplitude of the inverted-F antenna 201, S21 indicates an amplitude of coupling from the inverted-F antenna 202 to the inverted-F antenna 201, and S22 indicates a reflection amplitude of the inverted-F antenna 202.

In FIG. 4, since the two-element array antenna shown in FIG. 3 has a symmetrical structure, S11 indicating the reflection amplitude of the inverted-F antenna 201 and S22 indicating the reflection amplitude of the inverted-F antenna 202 overlap each other. In FIG. 4, it can be confirmed that the reflection amplitude of the inverted-F antenna 201 and the reflection amplitude of the inverted-F antenna 202 are reduced at the design frequency fc. On the other hand, in FIG. 4, since the distance between the inverted-F antenna 201 and the inverted-F antenna 202 is λc/2 or less, the amplitude of coupling from the inverted-F antenna 202 to the inverted-F antenna 201 is −2.7 dB at the design frequency fc, and it can be confirmed that it is very high at the design frequency fc.

In FIG. 5A, when the first phase shifter 110 is in mode 1, the circuit configuration shown in FIG. 1 is symmetrical, and therefore, S11 indicating the reflection amplitude of the inverted-F antenna 201 and S22 indicating the reflection amplitude of the inverted-F antenna 202 overlap each other.

In FIGS. 5A and 5B, even if the distance between the inverted-F antenna 201 and the inverted-F antenna 202 is λc/2 or less, it can be confirmed that all of the reflection amplitude of the inverted-F antenna 201, the reflection amplitude of the inverted-F antenna 202, and the amplitude of coupling from the inverted-F antenna 202 to the inverted-F antenna 201 are reduced at the design frequency fc.

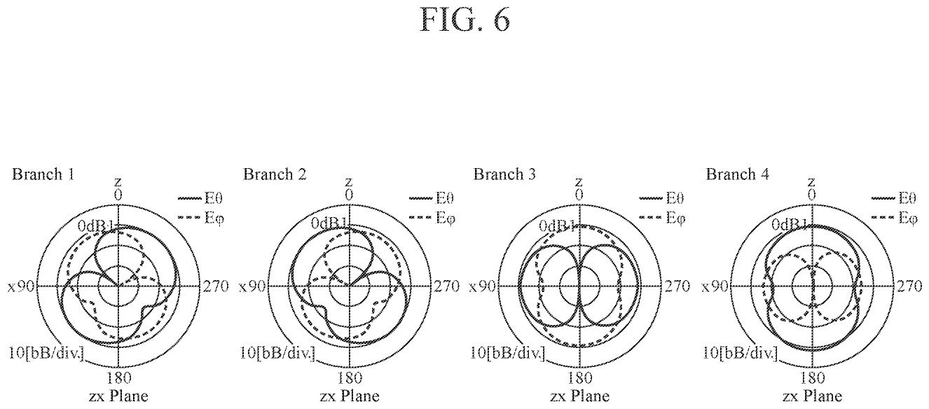

FIG. 6 is a diagram showing a radiation pattern calculation result of a ZX plane shown in FIG. 3 at the design frequency fc when the configuration shown in FIG. 3 is applied to the first radiation element 101 and the second radiation element 102 of the antenna device 100 according to the first embodiment. In FIG. 6, it can be confirmed that the shapes of the radiation patterns of the ZX plane at the design frequency fc of the four branches 1, 2, 3, and 4 are different from each other.

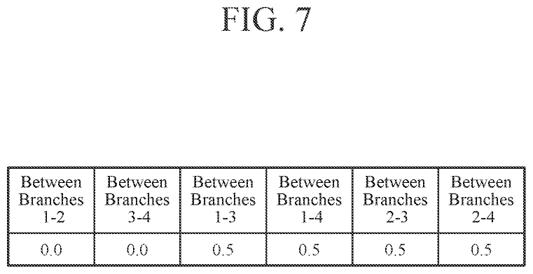

FIG. 7 is a diagram showing a calculation result of a correlation coefficient between each branch when the configuration shown in FIG. 3 is applied to the first radiation element 101 and the second radiation element 102 of the antenna device 100 according to the first embodiment. In particular, FIG. 7 shows the result of calculating the correlation coefficient between each branch when it is assumed that the antenna device 100 is installed in a multipath environment, and the incoming wave is supposed to be uniformly distributed in all directions. As shown in FIG. 7, all of the correlation coefficients between each branch in the antenna device 100 are 0.5 or less, and it can be confirmed that the antenna device 100 has a low-correlation 4-branch diversity function with low correlation.

As described above, the antenna device 100 includes the first radiation element 101, the second radiation element 102, the first input and output terminal 103, the second input and output terminal 104, the first phase shifter 110 having a first end connected to the second radiation element 102, the first susceptance element 105 having a first end connected to the first radiation element 101 and a second end connected to a second end of the first phase shifter 110, the second susceptance element 106 having a first end connected to a first end of the first susceptance element 105, the third susceptance element 107 having a first end connected to a second end of the first susceptance element 105, the fourth susceptance element 108 having a first end connected to a second end of the second susceptance element 106 and a second end connected to a second end of the third susceptance element 107, the first variable matching circuit 120 having a first end connected to a first end of the fourth susceptance element 108 and a second end connected to the first input and output terminal 103, and the second variable matching circuit 130 having a first end connected to a second end of the fourth susceptance element 108 and a second end connected to the second input and output terminal 104, in which

when power is supplied from the first input and output terminal 103 or the second input and output terminal 104, each susceptance value of the first susceptance element 105, the second susceptance element 106, the third susceptance element 107, and the fourth susceptance element 108 are set so that an excitation amplitude of the first radiation element 101 and an excitation amplitude of the second radiation element 102 have a substantially equal amplitude, and coupling between the first input and output terminal 103 and the second input and output terminal 104 is reduced.

With such a configuration, the antenna device 100 can reduce a signal loss even when the distance between two radiation elements is narrow while implementing the 4-branch diversity function with the two radiation elements.

A conventional 90-degree hybrid circuit is usually composed of a directional coupler or the like. When the 90-degree hybrid circuit is composed of a directional coupler, the directional coupler has a size of ¼ wavelength square, etc., and thus there is a problem that a power feeding circuit that feeds power to the radiation element is large.

For example, even if the power feeding circuit is miniaturized by configuring the directional coupler with lumped constant elements, the power feeding circuit requires eight or more lumped constant elements. Therefore, even if the power feeding circuit is composed of the directional coupler with lumped constant elements, there is a problem that the power feeding circuit requires a large number of elements and has a large circuit loss. Further, in the conventional 90-degree hybrid circuit, since the phase shift amount of the second phase shifter is 180 degrees, the excitation phase difference between the first radiation element and the second radiation element is only 90 degrees and 270 degrees, and there is a problem that substantively it will only work with 2-branch diversity.

By configuring the antenna device 100 as described above, it is possible to make the excitation amplitudes of the first radiation element 101 and the second radiation element 102 equal in amplitude while reducing the mutual coupling between the first radiation element 101 and the second radiation element 102 by the first susceptance element 105, the second susceptance element 106, the third susceptance element 107, and the fourth susceptance element 108, and therefore it is possible to adopt a simple configuration without using a directional coupler or the like.

By configuring the antenna device 100 as described above, the antenna device 100 can be made compact and have low loss.

Note that, although the first radiation element 101 and the second radiation element 102 according to the first embodiment have been described as being composed of the inverted-F antenna 201 and the inverted-F antenna 202 as an example, the first radiation element 101 and the second radiation element 102 are not limited to those composed of the inverted-F antenna 201 and the inverted-F antenna 202. Each of the first radiation element 101 and the second radiation element 102 may be composed of a monopole antenna, a dipole antenna, an inverted-L antenna, or the like.

### Second Embodiment

An antenna device 100a according to a second embodiment is an antenna device in which the first phase shifter 110, the first variable matching circuit 120, and the second variable matching circuit 130 of the antenna device 100 according to the first embodiment are changed to a first phase shifter 110a, a first variable matching circuit 120a, and a second variable matching circuit 130a, respectively.

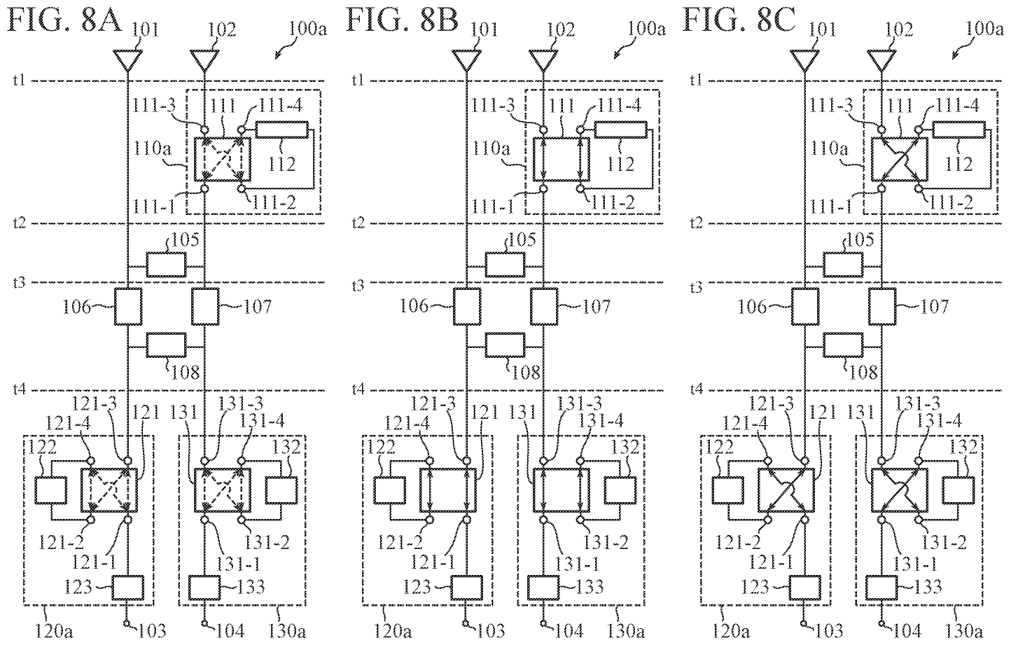

An example of the configuration of the main part of the antenna device 100a according to the second embodiment will be described with reference to FIG. 8.

FIG. 8A is a diagram showing an example of the configuration of the main part of the antenna device 100a according to the second embodiment.

In the configuration of the antenna device 100a according to the second embodiment, the same reference numerals are given to the same configurations as the antenna device 100 according to the first embodiment, and duplicate description will be omitted. That is, the description of the configuration of FIG. 8A having the same reference numerals as those shown in FIG. 1 will be omitted.

The antenna device 100a according to the second embodiment includes a first radiation element 101, a second radiation element 102, a first input and output terminal 103, a second input and output terminal 104, a first phase shifter 110a, a first susceptance element 105, a second susceptance element 106, a third susceptance element 107, a fourth susceptance element 108, a first variable matching circuit 120a, and a second variable matching circuit 130a.

The first phase shifter 110a according to the second embodiment is composed of a first DPDT (Double Pole, Double Throw) switch 111 and a first transmission line 112.

The first variable matching circuit 120a according to the second embodiment is composed of a second DPDT switch 121, a first matching circuit 122, and a second matching circuit 123.

The second variable matching circuit 130a according to the second embodiment is composed of a third DPDT switch 131, a third matching circuit 132, and a fourth matching circuit 133.

The first DPDT switch 111 has a first terminal 111-1, a second terminal 111-2, a third terminal 111-3, and a fourth terminal 111-4.

The first DPDT switch 111 has two states that are a first state in which the first terminal 111-1 is connected to the third terminal 111-3 and the second terminal 111-2 is connected to the fourth terminal 111-4, and a second state in which the first terminal 111-1 is connected to the fourth terminal 111-4 and the second terminal 111-2 is connected to the third terminal 111-3.

The first DPDT switch 111 switches between the first state and the second state by, for example, a control signal received from the outside of the device.

The second DPDT switch 121 has a fifth terminal 121-1, a sixth terminal 121-2, a seventh terminal 121-3, and an eighth terminal 121-4.

The second DPDT switch 121 has two states that are a third state in which the fifth terminal 121-1 is connected to the seventh terminal 121-3 and the sixth terminal 121-2 is connected to the eighth terminal 121-4, and a fourth state in which the fifth terminal 121-1 is connected to the eighth terminal 121-4 and the sixth terminal 121-2 is connected to the seventh terminal 121-3.

The second DPDT switch 121 switches between the third state and the fourth state by, for example, a control signal received from the outside of the device.

The third DPDT switch 131 has a ninth terminal 131-1, a tenth terminal 131-2, an eleventh terminal 131-3, and a twelfth terminal 131-4.

The third DPDT switch 131 has two states that are a fifth state in which the ninth terminal 131-1 is connected to the eleventh terminal 131-3 and the tenth terminal 131-2 is connected to the twelfth terminal 131-4, and a sixth state in which the ninth terminal 131-1 is connected to the twelfth terminal 131-4 and the tenth terminal 131-2 is connected to the eleventh terminal 131-3.

The third DPDT switch 131 switches between the fifth state and the sixth state by, for example, a control signal received from the outside of the device.

The first terminal 111-1 is connected to the other end of the first susceptance element 105.

The second terminal 111-2 is connected to one end of the first transmission line 112.

The third terminal 111-3 is connected to the second radiation element 102.

The fourth terminal 111-4 is connected to the other end of the first transmission line 112.

The fifth terminal 121-1 is connected to one end of the second matching circuit 123.

The sixth terminal 121-2 is connected to one end of the first matching circuit 122.

The seventh terminal 121-3 is connected to one end of the fourth susceptance element 108.

The eighth terminal 121-4 is connected to the other end of the first matching circuit 122.

The ninth terminal 131-1 is connected to one end of the fourth matching circuit 133.

The tenth terminal 131-2 is connected to one end of the third matching circuit 132.

The eleventh terminal 131-3 is connected to the other end of the fourth susceptance element 108.

The twelfth terminal 131-4 is connected to the other end of the third matching circuit 132.

The other end of the second matching circuit 123 is connected to the first input and output terminal 103.

The other end of the fourth matching circuit 133 is connected to the second input and output terminal 104.

The antenna device 100a switches by, for example, a control signal received from the outside of the device, between a mode in which the first DPDT switch 111 is in the first state, the second DPDT switch 121 is in the third state, and the third DPDT switch 131 is in the fifth state, and a mode in which the first DPDT switch 111 is in the second state, the second DPDT switch 121 is in the fourth state, and the third DPDT switch 131 is in the sixth state.

FIG. 8B is a diagram showing the states of the first DPDT switch 111, the second DPDT switch 121, and the third DPDT switch 131 when the first phase shifter 110a is in mode 1 in the antenna device 100a according to the second embodiment.

FIG. 8C is a diagram showing the states of the first DPDT switch 111, the second DPDT switch 121, and the third DPDT switch 131 when the first phase shifter 110a is in mode 2 in the antenna device 100a according to the second embodiment.

Hereinafter, the first transmission line 112 will be described as assuming that the phase of the signal input to the first transmission line 112 is shifted by +90 degrees.

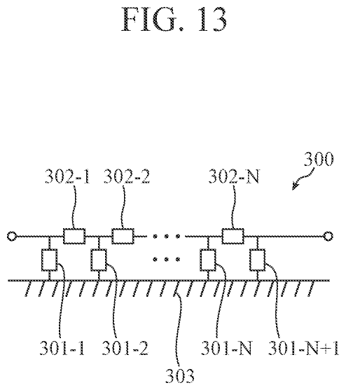

The first transmission line 112 may be, for example, one to which a phase shift circuit 300 shown in FIG. 13 is applied. The phase shift circuit 300 shown in FIG. 13 has a plurality of lumped constant elements which are one or more inductors 302-1, 302-2, . . . , 302-N (N is a natural number of one or more) and a plurality of capacitors 301-1, 301-2, . . . , 301-N, 301-N+1.

In the phase shift circuit 300, the capacitors 301-1, 301-2, . . . , 301-N, 301-N+1 connected in parallel and the inductors 302-1, 302-2, . . . , 302-N connected in series are alternately connected.

More specifically, one end of each inductor 302-M (M is a natural number of one or more and less than N) is connected to the other end of the inductor 302-M+1. Each of one ends of the capacitors 301-1, 301-2, . . . , 301-N, 301-N+1 is connected to the ground conductor 303. The other end of the inductor 302-1 and one ends of each inductor 302-M and inductor 302-N are connected to one end of the corresponding capacitor 301-L (L is a natural number of one or more and N+1 or less).

By applying the phase shift circuit 300 as shown in FIG. 13 to the first transmission line 112, the phase shift amount can be increased in the first transmission line 112 by combining a plurality of lumped constant elements. Further, since the phase shift circuit 300 is composed of only lumped constant elements, the size of the first transmission line 112 is reduced by applying the phase shift circuit 300 as shown in FIG. 13 to the first transmission line 112, and the antenna device 100a can be miniaturized.

When the first DPDT switch 111 is in the first state, the other end of the first susceptance element 105 is short-circuited to the second radiation element 102 via the first terminal 111-1 and the third terminal 111-3. When the first DPDT switch 111 is in the first state, the first phase shifter 110a is in a state of phase-shifting the signal input to the first phase shifter 110a by 0 degrees as the phase shift amount, that is, in mode 1.

Further, when the first DPDT switch 111 is in the second state, the other end of the first susceptance element 105 is connected to the second radiation element 102 via the first transmission line 112. When the first DPDT switch 111 is in the second state, the first phase shifter 110a is in a state of phase-shifting the signal input to the first phase shifter 110a by +90 degrees as the phase shift amount, that is, in mode 2.

Since the phases of mutual coupling when the first radiation element 101 and the second radiation element 102 side are viewed from the reference plane t2 shown in FIG. 8A are different between when the first DPDT switch 111 is in the first state and when the first DPDT switch 111 is in the second state, the phases of reflection when the first radiation element 101 and the second radiation element 102 side are viewed from the reference plane t4 shown in FIG. 8A are different.

In the antenna device 100a, when the first phase shifter 110a is in mode 1, the first variable matching circuit 120a is operated in the third state, and the second variable matching circuit 130a is operated in the fifth state, and when the first phase shifter 110a is in mode 2, the first variable matching circuit 120a is operated in the fourth state, and the second variable matching circuit 130a is operated in the sixth state.

Specifically, for example, in the antenna device 100a, when the first phase shifter 110a is in mode 1, one end of the second matching circuit 123 is short-circuited to one end of the fourth susceptance element 108 via the fifth terminal 121-1 and the seventh terminal 121-3. Further, in the antenna device 100a, when the first phase shifter 110a is in mode 2, one end of the second matching circuit 123 is connected to one end of the fourth susceptance element 108 via the first matching circuit 122.

In the antenna device 100a, when the first phase shifter 110a is in mode 1, the second matching circuit 123 reduces the reflection amplitude of the signal input from the first input and output terminal 103. Further, in the antenna device 100a, when the first phase shifter 110a is in mode 2, the first matching circuit 122 and the second matching circuit 123 reduce the reflection amplitude of the signal input from the first input and output terminal 103.

Further, for example, in the antenna device 100a, when the first phase shifter 110a is in mode 1, one end of the fourth matching circuit 133 is short-circuited to the other end of the fourth susceptance element 108 via the ninth terminal 131-1 and the eleventh terminal 131-3. Further, in the antenna device 100a, when the first phase shifter 110a is in mode 2, one end of the fourth matching circuit 133 is connected to the other end of the fourth susceptance element 108 via the third matching circuit 132.

In the antenna device 100a, when the first phase shifter 110a is in mode 1, the fourth matching circuit 133 reduces the reflection amplitude of the signal input from the second input and output terminal 104. Further, in the antenna device 100a, when the first phase shifter 110a is in mode 2, the third matching circuit 132 and the fourth matching circuit 133 reduce the reflection amplitude of the signal input from the second input and output terminal 104.

Each of the first matching circuit 122, the second matching circuit 123, the third matching circuit 132, and the fourth matching circuit 133 is composed of, for example, a Π type circuit having three lumped constant elements. The configuration of the first matching circuit 122, the second matching circuit 123, the third matching circuit 132, and the fourth matching circuit 133 is not limited to the Π type circuit, and may be a T type circuit or the like.

As described above, in the antenna device 100a, it is possible to reduce a signal loss even when the distance between two radiation elements is narrow, while implementing a 4-branch diversity function with the two radiation elements by switching between the state of the second variable matching circuit 130a and the state of the first variable matching circuit 120a according to the mode of the first phase shifter 110a.

Further, with such a configuration, since the antenna device 100a can make the excitation amplitudes of the first radiation element 101 and the second radiation element 102 equal in amplitude while reducing the mutual coupling between the first radiation element 101 and the second radiation element 102 by the first susceptance element 105, the second susceptance element 106, the third susceptance element 107, and the fourth susceptance element 108, it is possible to adopt a simple configuration without using a directional coupler or the like.

Further, with such a configuration, the antenna device 100a can be made compact and have low loss.

Note that, in the antenna device 100a, if when the first phase shifter 110a is in mode 1, the phase shift amount from one end of the first susceptance element 105 to the first radiation element 101 and the phase shift amount from the other end of the first susceptance element 105 to the second radiation element 102 are equal to each other, and when the first phase shifter 110a is in mode 2, the phase shift amount from the other end of the first susceptance element 105 to the second radiation element 102 is larger than the phase shift amount from one end of the first susceptance element 105 to the first radiation element 101 by 90 degrees, for example, between one end of the first susceptance element 105 and the first radiation element 101, between the other end of the first susceptance element 105 and the first terminal 111-1, or between the third terminal 111-3 and the second radiation element 102 may be connected via a transmission line (not shown).

### Third Embodiment

An antenna device 100b according to a third embodiment is an antenna device in which the first phase shifter 110, the first variable matching circuit 120, and the second variable matching circuit 130 of the antenna device 100 according to the first embodiment are respectively changed to a third phase shifter 150, a fifth matching circuit 160, and a sixth matching circuit 170, and further a second phase shifter 140 is added between the first radiation element 101 and the second susceptance element 106.

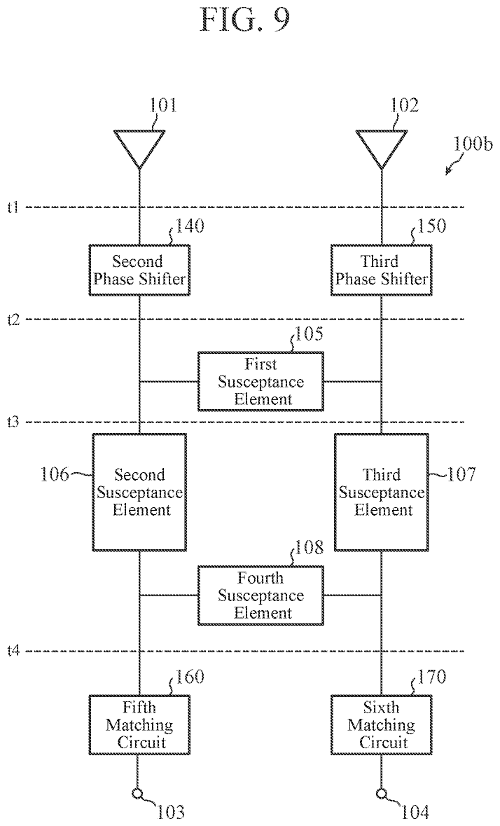

An example of the configuration of the main part of the antenna device 100b according to the third embodiment will be described with reference to FIG. 9.

In the configuration of the antenna device 100b according to the third embodiment, the same reference numerals are given to the same configurations as the antenna device 100 according to the first embodiment, and duplicate description will be omitted. That is, the description of the configuration of FIG. 9 having the same reference numerals as those shown in FIG. 1 will be omitted.

The antenna device 100b according to the third embodiment includes a first radiation element 101, a second radiation element 102, a first input and output terminal 103, a second input and output terminal 104, a second phase shifter 140, a third phase shifter 150, a first susceptance element 105, a second susceptance element 106, a third susceptance element 107, a fourth susceptance element 108, a fifth matching circuit 160, and a sixth matching circuit 170.

One end of the second phase shifter 140 is connected to the first radiation element 101.

One end of the third phase shifter 150 is connected to the second radiation element 102.

One end of the first susceptance element 105 is connected to the other end of the second phase shifter 140.

The other end of the first susceptance element 105 is connected to the other end of the third phase shifter 150.

One end of the second susceptance element 106 is connected to one end of the first susceptance element 105.

One end of the third susceptance element 107 is connected to the other end of the first susceptance element 105.

One end of the fourth susceptance element 108 is connected to the other end of the second susceptance element 106.

The other end of the fourth susceptance element 108 is connected to the other end of the third susceptance element 107.

One end of the fifth matching circuit 160 is connected to one end of the fourth susceptance element 108.

The other end of the fifth matching circuit 160 is connected to the first input and output terminal 103.

One end of the sixth matching circuit 170 is connected to the other end of the fourth susceptance element 108.

The other end of the sixth matching circuit 170 is connected to the second input and output terminal 104.

The second phase shifter 140 shifts the phase of the signal input to the second phase shifter 140.

Specifically, the second phase shifter 140 has two states that are a state of shifting the phase of the signal input to the second phase shifter 140 by +45 degrees as the phase shift amount, and a state of shifting the phase of the signal input to the second phase shifter 140 by 0 degrees as the phase shift amount. The state of the second phase shifter 140 is switched to either state of the two states by, for example, a control signal received from the outside of the device.

The third phase shifter 150 shifts the phase of the signal input to the third phase shifter 150.

Specifically, the third phase shifter 150 has two states that are a state of shifting the phase of the signal input to the third phase shifter 150 by +α (α is a value of 0 or more and less than 360) degrees as the phase shift amount, and a state of shifting the phase of the signal input to the third phase shifter 150 by +45+α degrees as the phase shift amount.

The third phase shifter 150, in synchronization with switching of the second phase shifter 140 to a state of phase-shifting the signal input to the second phase shifter 140 by +45 degrees as the phase shift amount, is switched, for example by a control signal received from the outside of the device, to a state of phase-shifting the signal input to the third phase shifter 150 by +α degrees as the phase shift amount, and the third phase shifter 150, in synchronization with switching of the second phase shifter 140 to a state of phase-shifting the signal input to the second phase shifter 140 by 0 degrees as the phase shift amount, is switched to a state of phase-shifting the signal input to the third phase shifter 150 by +45+α degrees as the phase shift amount.

It should be noted that the +45 degrees referred to here is not limited to strict +45 degrees, but includes approximately +45 degrees. Hereinafter, +45 degrees will be described as including approximately +45 degrees.

The fifth matching circuit 160 and the sixth matching circuit 170 reduce the reflection amplitudes at the first input and output terminal 103 and the second input and output terminal 104 by matching the impedance in the antenna device 100b.

Each of the fifth matching circuit 160 and the sixth matching circuit 170 is composed of, for example, a Π type circuit having three lumped constant elements. The configuration of each of the fifth matching circuit 160 and the sixth matching circuit 170 is not limited to the Π type circuit, and may be a T type circuit or the like.

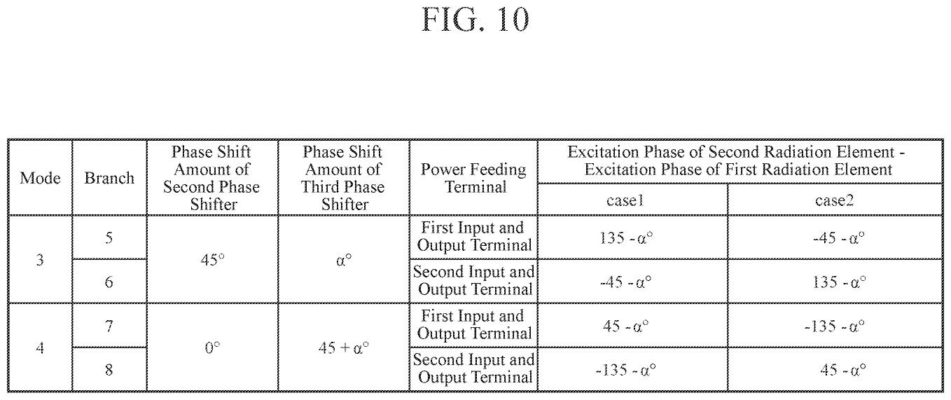

The operating mechanism of the antenna device 100b according to the third embodiment will be described with reference to FIG. 10.

Hereinafter, a case where the second phase shifter 140 is in a state of shifting the phase of the signal input to the second phase shifter 140 by +45 degrees as the phase shift amount, and the third phase shifter 150 is in a state of phase-shifting the signal input to the third phase shifter 150 by +α degrees as the phase shift amount (hereinafter referred to as “mode 3”) will be described.

The phase difference obtained by subtracting the excitation phase of the first radiation element 101 from the excitation phase of the second radiation element 102 is different between the case where power is supplied from the first input and output terminal 103 and the case where power is supplied from the second input and output terminal 104, due to the characteristics of the circuit composed of the first susceptance element 105, the second susceptance element 106, the third susceptance element 107, and the fourth susceptance element 108.

Specifically, when the susceptance value B₁ of the first susceptance element 105 is case 1, the phase difference obtained by subtracting the excitation phase of the first radiation element 101 from the excitation phase of the second radiation element 102 is +135−α degrees when power is supplied from the first input and output terminal 103, and is −45−α degrees when power is supplied from the second input and output terminal 104.

On the other hand, when the susceptance value B₁ of the first susceptance element 105 is case 2, the phase difference obtained by subtracting the excitation phase of the first radiation element 101 from the excitation phase of the second radiation element 102 is −45−α degrees when power is supplied from the first input and output terminal 103, and is +135−α degrees when power is supplied from the second input and output terminal 104.

Similarly, when the second phase shifter 140 is in a state of shifting the phase of the signal input to the second phase shifter 140 by 0 degrees as the phase shift amount, and the third phase shifter 150 is in a state of phase-shifting the signal input to the third phase shifter 150 by +45+α degrees as the phase shift amount (hereinafter referred to as “mode 4”), and when the susceptance value B₁ of the first susceptance element 105 is case 1, the phase difference obtained by subtracting the excitation phase of the first radiation element 101 from the excitation phase of the second radiation element 102 is +45−α degrees when power is supplied from the first input and output terminal 103, and is −135−α degrees when power is supplied from the second input and output terminal 104. Further, when the second phase shifter 140 and the third phase shifter 150 are in mode 4, and when the susceptance value B₁ of the first susceptance element 105 is case 2, the phase difference obtained by subtracting the excitation phase of the first radiation element 101 from the excitation phase of the second radiation element 102 is −135−α degrees when power is supplied from the first input and output terminal 103, and is +45−α degrees when power is supplied from the second input and output terminal 104.

Hereinafter, a case where the susceptance value B₁ of the first susceptance element 105 is case 1 will be described.

When the second phase shifter 140 and the third phase shifter 150 are in mode 3, and when power is supplied from the first input and output terminal 103, the antenna device 100b forms one branch (hereinafter referred to as “branch 5”) in which the phase difference obtained by subtracting the excitation phase of the first radiation element 101 from the excitation phase of the second radiation element 102 is +135−α degrees.

When the second phase shifter 140 and the third phase shifter 150 are in mode 3, and when power is supplied from the second input and output terminal 104, the antenna device 100b forms one branch (hereinafter referred to as “branch 6”) in which the phase difference obtained by subtracting the excitation phase of the first radiation element 101 from the excitation phase of the second radiation element 102 is −45−α degrees.

When the second phase shifter 140 and the third phase shifter 150 are in mode 4, and when power is supplied from the first input and output terminal 103, the antenna device 100b forms one branch (hereinafter referred to as “branch 7”) in which the phase difference obtained by subtracting the excitation phase of the first radiation element 101 from the excitation phase of the second radiation element 102 is +45−α degrees.

When the second phase shifter 140 and the third phase shifter 150 are in mode 4, and when power is supplied from the second input and output terminal 104, the antenna device 100b forms one branch (hereinafter referred to as “branch 8”) in which the phase difference obtained by subtracting the excitation phase of the first radiation element 101 from the excitation phase of the second radiation element 102 is −135−α degrees.

In this way, in the antenna device 100b, the second phase shifter 140 and the third phase shifter 150 are switched to either mode 3 or mode 4, for example, by a control signal received from the outside of the device, and power is controlled to be supplied from the first input and output terminal 103 or the second input and output terminal 104, and thereby it is possible to configure a 4-branch diversity function in which the phase difference obtained by subtracting the excitation phase of the first radiation element 101 from the excitation phase of the second radiation element 102 will be +45−α degrees, +135−α degrees, +225−α degrees (−135−α degrees), or +315−α degrees (−45−α degrees).

In the antenna device 100b, also when the susceptance value B₁ of the first susceptance element 105 is case 2, similarly to the case where the susceptance value B₁ of the first susceptance element 105 is case 1, the second phase shifter 140 and the third phase shifter 150 are switched to either mode 3 or mode 4, for example, by a control signal received from the outside of the device, and power is controlled to be supplied from the first input and output terminal 103 or the second input and output terminal 104, and thereby it is possible to configure a 4-branch diversity function in which the phase difference obtained by subtracting the excitation phase of the first radiation element 101 from the excitation phase of the second radiation element 102 will be +45−α degrees, +135−α degrees, +225−α degrees (−135−α degrees), or +315−α degrees (−45−α degrees).

In the antenna device 100b, when the second phase shifter 140 and the third phase shifter 150 are in mode 3, and when the second phase shifter 140 and the third phase shifter 150 are in mode 4, the phases of mutual coupling when the first radiation element 101 and the second radiation element 102 side are viewed from the reference plane t2 shown in FIG. 9 are equal. Therefore, the phases of reflection when the first radiation element 101 and the second radiation element 102 side are viewed from the reference plane t4 shown in FIG. 9 are also equal. Therefore, in the antenna device 100b, when the second phase shifter 140 and the third phase shifter 150 are in mode 3, and when the second phase shifter 140 and the third phase shifter 150 are in mode 4, the fifth matching circuit 160 and the sixth matching circuit 170 do not have to be variable, and the non-variable fifth matching circuit 160 and the non-variable sixth matching circuit 170 can reduce reflection amplitudes at the first input and output terminal 103 and the second input and output terminal 104.

As described above, the antenna device 100b includes the first radiation element 101, the second radiation element 102, the first input and output terminal 103, the second input and output terminal 104, the second phase shifter 140 having a first end connected to the first radiation element 101, the third phase shifter 150 having a first end connected to the second radiation element 102, the first susceptance element 105 having a first end connected to a second end of the second phase shifter 140 and a second end connected to a second end of the third phase shifter 150, the second susceptance element 106 having a first end connected to a first end of the first susceptance element 105, the third susceptance element 107 having a first end connected to a second end of the first susceptance element 105, the fourth susceptance element 108 having a first end connected to a second end of the second susceptance element 106 and a second end connected to a second end of the third susceptance element 107, the fifth matching circuit 160 having a first end connected to a first end of the fourth susceptance element 108 and a second end connected to the first input and output terminal 103, and the sixth matching circuit 170 having a first end connected to a second end of the fourth susceptance element 108 and a second end connected to the second input and output terminal 104, in which

when power is supplied from the first input and output terminal 103 or the second input and output terminal 104, each susceptance values of the first susceptance element 105, the second susceptance element 106, the third susceptance element 107, and the fourth susceptance element 108 are set so that an excitation amplitude of the first radiation element 101 and an excitation amplitude of the second radiation element 102 have a substantially equal amplitude, and coupling between the first input and output terminal 103 and the second input and output terminal 104 is reduced.

With such a configuration, the antenna device 100b can reduce a signal loss even when the distance between two radiation elements is narrow while implementing the 4-branch diversity function with the two radiation elements.

Further, with such a configuration, in the antenna device 100b, it is possible to make the excitation amplitudes of the first radiation element 101 and the second radiation element 102 equal in amplitude while reducing the mutual coupling between the first radiation element 101 and the second radiation element 102 by the first susceptance element 105, the second susceptance element 106, the third susceptance element 107, and the fourth susceptance element 108, and therefore it is possible to adopt a simple configuration without using a directional coupler or the like.

Further, with such a configuration, the antenna device 100b can be made compact and have low loss.

### Fourth Embodiment

An antenna device 100c according to a fourth embodiment is an antenna device in which the second phase shifter 140 and the third phase shifter 150 of the antenna device 100b according to the third embodiment are changed to a second phase shifter 140c and a third phase shifter 150c, respectively.

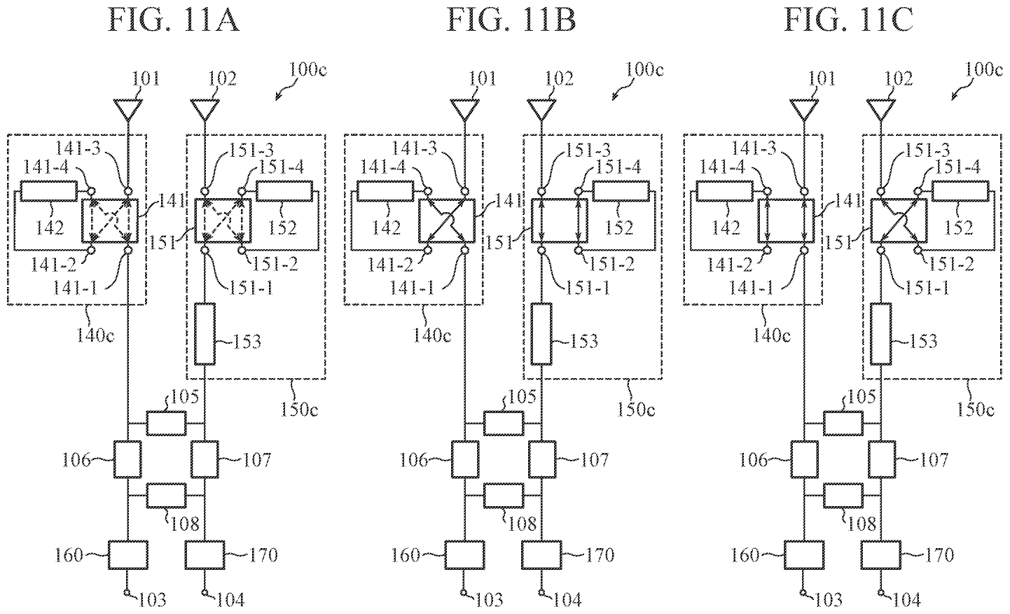

An example of the configuration of the main part of the antenna device 100c according to the fourth embodiment will be described with reference to FIG. 11.

FIG. 11A is a diagram showing an example of the configuration of the main part of the antenna device 100c according to the fourth embodiment.

In the configuration of the antenna device 100c according to the fourth embodiment, the same reference numerals are given to the same configurations as the antenna device 100b according to the third embodiment, and duplicate description will be omitted. That is, the description of the configuration of FIG. 11A having the same reference numerals as those shown in FIG. 9 will be omitted.

The antenna device 100c according to the fourth embodiment includes a first radiation element 101, a second radiation element 102, a first input and output terminal 103, a second input and output terminal 104, a second phase shifter 140c, a third phase shifter 150c, a first susceptance element 105, a second susceptance element 106, a third susceptance element 107, a fourth susceptance element 108, a fifth matching circuit 160, and a sixth matching circuit 170.

The second phase shifter 140c according to the fourth embodiment is composed of a fourth DPDT switch 141 and a second transmission line 142.

The third phase shifter 150c according to the fourth embodiment is composed of a fifth DPDT switch 151, a third transmission line 152, and a fourth transmission line 153.

The fourth DPDT switch 141 has a thirteenth terminal 141-1, a fourteenth terminal 141-2, a fifteenth terminal 141-3, and a sixteenth terminal 141-4.

The fourth DPDT switch 141 has two states that are a seventh state in which the thirteenth terminal 141-1 is connected to the sixteenth terminal 141-4 and the fourteenth terminal 141-2 is connected to the fifteenth terminal 141-3, and an eighth state in which the thirteenth terminal 141-1 is connected to the fifteenth terminal 141-3 and the fourteenth terminal 141-2 is connected to the sixteenth terminal 141-4.

The fourth DPDT switch 141 is switched between the seventh state and the eighth state by, for example, a control signal received from the outside of the device.

The fifth DPDT switch 151 has a seventeenth terminal 151-1, an eighteenth terminal 151-2, a nineteenth terminal 151-3, and a twentieth terminal 151-4.

The fifth DPDT switch 151 has two states that are a ninth state in which the seventeenth terminal 151-1 is connected to the nineteenth terminal 151-3 and the eighteenth terminal 151-2 is connected to the twentieth terminal 151-4, and a tenth state in which the seventeenth terminal 151-1 is connected to the twentieth terminal 151-4 and the eighteenth terminal 151-2 is connected to the nineteenth terminal 151-3.

The fifth DPDT switch 151 is switched between the ninth state and the tenth state by, for example, a control signal received from the outside of the device.

The thirteenth terminal 141-1 is connected to one end of the first susceptance element 105.

The fourteenth terminal 141-2 is connected to one end of the second transmission line 142.

The fifteenth terminal 141-3 is connected to the first radiation element 101.

The sixteenth terminal 141-4 is connected to the other end of the second transmission line 142.

The seventeenth terminal 151-1 is connected to one end of the fourth transmission line 153.

The eighteenth terminal 151-2 is connected to one end of the third transmission line 152.

The nineteenth terminal 151-3 is connected to the second radiation element 102.

The twentieth terminal 151-4 is connected to the other end of the third transmission line 152.

The other end of the fourth transmission line 153 is connected to the other end of the first susceptance element 105.

The antenna device 100c is switched between a mode in which the fourth DPDT switch 141 is in the seventh state and the fifth DPDT switch 151 is in the ninth state, and a mode in which the fourth DPDT switch 141 is in the eighth state and the fifth DPDT switch 151 is in the tenth state.

Hereinafter, it is assumed that the second transmission line 142 shifts the phase of the signal input to the second transmission line 142 by +45 degrees, the third transmission line 152 shifts the phase of the signal input to the third transmission line 152 by +45 degrees, and the fourth transmission line 153 shifts the phase of the signal input to the fourth transmission line 153 by +α degrees.

The second transmission line 142, the third transmission line 152, or the fourth transmission line 153 may be, for example, one to which the phase shift circuit 300 shown in FIG. 13 is applied. Since the phase shift circuit 300 has already been described, the description thereof will be omitted.

By applying the phase shift circuit 300 as shown in FIG. 13 to the second transmission line 142, the third transmission line 152, or the fourth transmission line 153, the second transmission line 142, the third transmission line 152, or the fourth transmission line 153 can increase the phase shift amount by combining a plurality of lumped constant elements. Further, since the phase shift circuit 300 is composed of only lumped constant elements, by applying the phase shift circuit 300 as shown in FIG. 13 to the second transmission line 142, the third transmission line 152, or the fourth transmission line 153, the size of the second transmission line 142, the third transmission line 152, or the fourth transmission line 153 is reduced, and the antenna device 100c can be miniaturized.

FIG. 11B is a diagram showing the states of the fourth DPDT switch 141 and the fifth DPDT switch 151 when the second phase shifter 140c and the third phase shifter 150c are in mode 3 in the antenna device 100c according to the fourth embodiment.

FIG. 11C is a diagram showing the states of the fourth DPDT switch 141 and the fifth DPDT switch 151 when the second phase shifter 140c and the third phase shifter 150c are in mode 4 in the antenna device 100c according to the fourth embodiment.

When the fourth DPDT switch 141 is in the seventh state, one end of the first susceptance element 105 is connected to the first radiation element 101 via the second transmission line 142. When the fourth DPDT switch 141 is in the seventh state, the second phase shifter 140c is in a state of phase-shifting the signal input to the second phase shifter 140c by +45 degrees as the phase shift amount.

Further, when the fifth DPDT switch 151 is in the 9th state, the other end of the first susceptance element 105 is connected to the second radiation element 102 via the fourth transmission line 153, the seventeenth terminal 151-1, and the nineteenth terminal 151-3. When the fifth DPDT switch 151 is in the ninth state, the third phase shifter 150c is in a state of phase-shifting the signal input to the third phase shifter 150c by +α degrees as the phase shift amount.

When the antenna device 100c is switched to a mode in which the fourth DPDT switch 141 is in the seventh state, and the fifth DPDT switch 151 is in the ninth state, the second phase shifter 140c and the third phase shifter 150c are in a mode in which the second phase shifter 140c is in a state of shifting the phase of the signal input to the second phase shifter 140c by +45 degrees as the phase shift amount, and the third phase shifter 150c is in a state of phase-shifting the signal input to the third phase shifter 150c by +α degrees as the phase shift amount, that is, in mode 3.

When the fourth DPDT switch 141 is in the eighth state, one end of the first susceptance element 105 is short-circuited to the first radiation element 101 via the thirteenth terminal 141-1 and the fifteenth terminal 141-3. When the fourth DPDT switch 141 is in the eighth state, the second phase shifter 140c is in a state of phase-shifting the signal input to the second phase shifter 140c by 0 degrees as the phase shift amount.

Further, when the fifth DPDT switch 151 is in the tenth state, the other end of the first susceptance element 105 is connected to the second radiation element 102 via the fourth transmission line 153 and the third transmission line 152. When the fifth DPDT switch 151 is in the tenth state, the third phase shifter 150c is in a state of phase-shifting the signal input to the third phase shifter 150c by +45+α degrees as the phase shift amount.

When the antenna device 100c is switched to a mode in which the fourth DPDT switch 141 is in the eighth state and the fifth DPDT switch 151 is in the tenth state, the second phase shifter 140c and the third phase shifter 150c are in a state in which the second phase shifter 140c is in a state of shifting the phase of the signal input to the second phase shifter 140c by 0 degrees as the phase shift amount, and the third phase shifter 150c is in a state of phase-shifting the signal input to the third phase shifter 150c by +45+α degrees as the phase shift amount, that is, in mode 4.

As described above, in the antenna device 100c, it is possible to reduce a signal loss even when the distance between two radiation elements is narrow, while implementing the 4-branch diversity function with the two radiation elements by switching modes of the second phase shifter 140c and the third phase shifter 150c.

Further, with such a configuration, the antenna device 100c can make the excitation amplitudes of the first radiation element 101 and the second radiation element 102 equal in amplitude while reducing the mutual coupling between the first radiation element 101 and the second radiation element 102 by the first susceptance element 105, the second susceptance element 106, the third susceptance element 107, and the fourth susceptance element 108, and therefore it is possible to adopt a simple configuration without using a directional coupler or the like.

Further, with such a configuration, the antenna device 100c can be made compact and have low loss.

Further, since the antenna device 100c can be configured by two DPDT switches while the number of DPDT switches of the antenna device 100a according to the second embodiment is three, the number of DPDT switches can be reduced.

Further, since the antenna device 100c can be configured by two matching circuits while the number of matching circuits in the antenna device 100a according to the second embodiment is four, the number of matching circuits can be reduced.

Further, in the antenna device 100c, since the total of the phase shift amount from one end of the first susceptance element 105 to the first radiation element 101 and the phase shift amount from the other end of the first susceptance element 105 to the second radiation element 102 is equal between mode 3 and mode 4, it is not necessary to switch the fifth matching circuit 160 or the sixth matching circuit 170 in synchronization with the mode switching of the second phase shifter 140c and the third phase shifter 150c. The fifth matching circuit 160 or the sixth matching circuit 170 can reduce the reflection amplitude when power is supplied from the first input and output terminal 103 and the second input and output terminal 104 in both mode 3 and mode 4.

Note that, in the antenna device 100c, the total length of the second transmission line 142, the third transmission line 152, and the fourth transmission line 153 is longer than the length of the first transmission line 112 of the antenna device 100a according to the second embodiment by the phase shift amount of +α degrees. However, in the antenna device 100c, the fourth transmission line 153 can also be deleted by setting a to 0. In this case, in the antenna device 100c, the total length of the second transmission line 142, the third transmission line 152, and the fourth transmission line 153 is equal to the length of the first transmission line 112 of the antenna device 100a according to the second embodiment.

Note that, in the antenna device 100c, in a case where the second phase shifter 140c and the third phase shifter 150c are in mode 3, when the phase shift amount from the other end of the first susceptance element 105 to the second radiation element 102 is larger than the phase shift amount from one end of the first susceptance element 105 to the first radiation element 101 by −45+α degrees and the second phase shifter 140c and the third phase shifter 150c are in mode 4, if the phase shift amount from the other end of the first susceptance element 105 to the second radiation element 102 is larger than the phase shift amount from one end of the first susceptance element 105 to the first radiation element 101 by 45+α degrees, for example, between one end of the first susceptance element 105 and the thirteenth terminal 141-1, between the fifteenth terminal 141-3 and the first radiation element 101, or between the nineteenth terminal 151-3 and the second radiation element 102 may be connected via a transmission line (not shown).

### Fifth Embodiment

An antenna device 100d according to a fifth embodiment is an antenna device in which the second phase shifter 140c and the third phase shifter 150c of the antenna device 100c according to a fourth embodiment are changed to a second phase shifter 140d and a third phase shifter 150d, respectively.

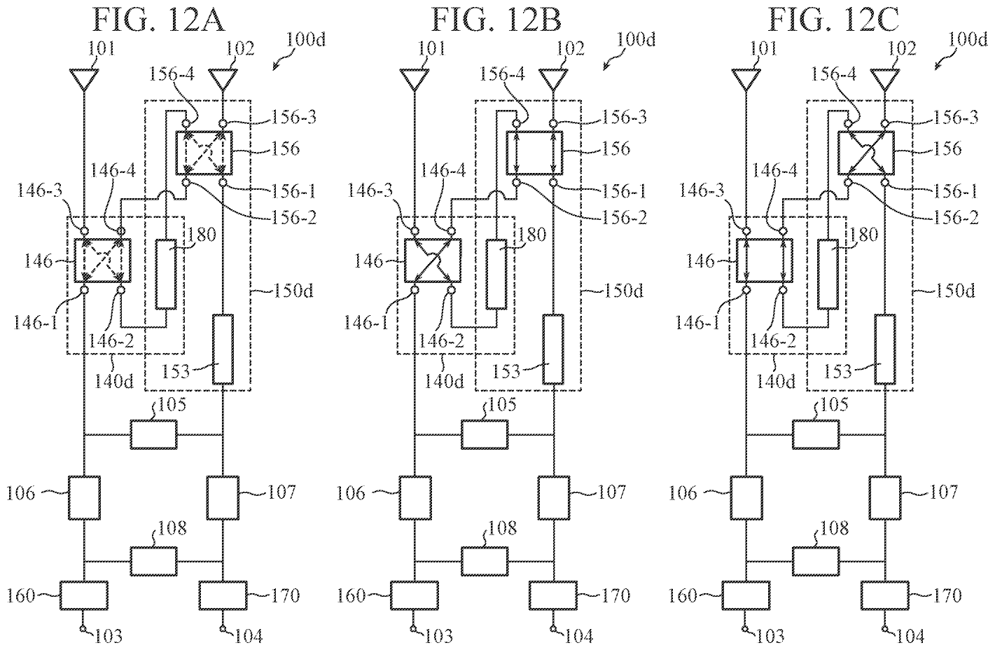

An example of the configuration of the main part of the antenna device 100d according to the fifth embodiment will be described with reference to FIG. 12.

FIG. 12A is a diagram showing an example of the configuration of the main part of the antenna device 100d according to the fifth embodiment.

In the configuration of the antenna device 100d according to the fifth embodiment, the same reference numerals are given to the same configurations as the antenna device 100c according to the fourth embodiment, and duplicate description will be omitted. That is, the description of the configuration of FIG. 12A having the same reference numerals as those shown in FIG. 11A will be omitted.

The antenna device 100d according to the fifth embodiment includes a first radiation element 101, a second radiation element 102, a first input and output terminal 103, a second input and output terminal 104, a second phase shifter 140d, a third phase shifter 150d, a first susceptance element 105, a second susceptance element 106, a third susceptance element 107, a fourth susceptance element 108, a fifth matching circuit 160, and a sixth matching circuit 170.

The second phase shifter 140d according to the fifth embodiment is composed of a sixth DPDT switch 146 and a fifth transmission line 180.

The third phase shifter 150d according to the fifth embodiment is composed of a seventh DPDT switch 156, the fifth transmission line 180, and a fourth transmission line 153.

That is, the fifth transmission line 180 of the second phase shifter 140d according to the fifth embodiment and the fifth transmission line 180 of the third phase shifter 150d according to the fifth embodiment are a common transmission line, which is obtained by making shared the second transmission line 142 of the second phase shifter 140c according to the fourth embodiment and the third transmission line 152 of the third phase shifter 150c according to the fourth embodiment.

The sixth DPDT switch 146 has a twenty-first terminal 146-1, a twenty-second terminal 146-2, a twenty-third terminal 146-3, and a twenty-fourth terminal 146-4.

The sixth DPDT switch 146 has two states that are an eleventh state in which the twenty-first terminal 146-1 is connected to the twenty-fourth terminal 146-4 and the twenty-second terminal 146-2 is connected to the twenty-third terminal 146-3, and a twelfth state in which the twenty-first terminal 146-1 is connected to the twenty-third terminal 146-3 and the twenty-second terminal 146-2 is connected to the twenty-fourth terminal 146-4.

The sixth DPDT switch 146 is switched between the eleventh state and the twelfth state by, for example, a control signal received from the outside of the device.

The seventh DPDT switch 156 has a twenty-fifth terminal 156-1, a twenty-sixth terminal 156-2, a twenty-seventh terminal 156-3, and a twenty-eighth terminal 156-4.

The seventh DPDT switch 156 has two states that are a thirteenth state in which the twenty-fifth terminal 156-1 is connected to the twenty-seventh terminal 156-3 and the twenty-sixth terminal 156-2 is connected to the twenty-eighth terminal 156-4, and a fourteenth state in which the twenty-fifth terminal 156-1 is connected to the twenty-eighth terminal 156-4 and the twenty-sixth terminal 156-2 is connected to the twenty-seventh terminal 156-3.

The seventh DPDT switch 156 is switched between the thirteenth state and the fourteenth state by, for example, a control signal received from the outside of the device.

The twenty-first terminal 146-1 is connected to one end of the first susceptance element 105.

The twenty-second terminal 146-2 is connected to one end of the fifth transmission line 180.

The twenty-third terminal 146-3 is connected to the first radiation element 101.

The twenty-fourth terminal 146-4 is connected to the twenty-sixth terminal 156-2.

The twenty-fifth terminal 156-1 is connected to one end of the fourth transmission line 153.

The twenty-seventh terminal 156-3 is connected to the second radiation element 102.

The twenty-eighth terminal 156-4 is connected to the other end of the fifth transmission line 180.

The other end of the fourth transmission line 153 is connected to the other end of the first susceptance element 105.

The antenna device 100d is switched between a mode in which the sixth DPDT switch 146 is in the eleventh state and the seventh DPDT switch 156 is in the thirteenth state and a mode in which the sixth DPDT switch 146 is in the twelfth state and the seventh DPDT switch 156 is in the fourteenth state.

Hereinafter, it is assumed that the fourth transmission line 153 shifts the phase of the signal input to the fourth transmission line 153 by +α degrees, and the fifth transmission line 180 shifts the phase of the signal input to the fifth transmission line 180 by +45 degrees.

The fourth transmission line 153 or the fifth transmission line 180 may be, for example, one to which the phase shift circuit 300 shown in FIG. 13 is applied. Since the phase shift circuit 300 has already been described, the description thereof will be omitted.

By applying the phase shift circuit 300 as shown in FIG. 13 to the fourth transmission line 153 or the fifth transmission line 180, the fourth transmission line 153 or the fifth transmission line 180 can increase the phase shift amount by combining a plurality of lumped constant elements. Further, since the phase shift circuit 300 is composed of only lumped constant elements, by applying the phase shift circuit 300 as shown in FIG. 13 to the fourth transmission line 153 or the fifth transmission line 180, the size of the fourth transmission line 153 or the fifth transmission line 180 is reduced, and the antenna device 100d can be miniaturized.

FIG. 12B is a diagram showing the states of the sixth DPDT switch 146 and the seventh DPDT switch 156 when the second phase shifter 140d and the third phase shifter 150d are in mode 3 in the antenna device 100d according to the fifth embodiment.

FIG. 12C is a diagram showing the states of the sixth DPDT switch 146 and the seventh DPDT switch 156 when the second phase shifter 140d and the third phase shifter 150d are in mode 4 in the antenna device 100d according to the fifth embodiment.

When the sixth DPDT switch 146 is in the eleventh state, and the seventh DPDT switch 156 is in the thirteenth state, one end of the first susceptance element 105 is connected to the first radiation element 101 via the fifth transmission line 180. When the sixth DPDT switch 146 is in the eleventh state and the seventh DPDT switch 156 is in the thirteenth state, the second phase shifter 140d is in a state of phase-shifting the signal input to the second phase shifter 140d by +45 degrees as the phase shift amount.

When the seventh DPDT switch 156 is in the thirteenth state, the other end of the first susceptance element 105 is connected to the second radiation element 102 via the fourth transmission line 153. When the seventh DPDT switch 156 is in the thirteenth state, the third phase shifter 150d is in a state of phase-shifting the signal input to the third phase shifter 150d by +α degrees as the phase shift amount.

When the antenna device 100d is switched to a mode in which the sixth DPDT switch 146 is in the eleventh state and the seventh DPDT switch 156 is in the thirteenth state, the second phase shifter 140d and the third phase shifter 150d are in a mode in which the second phase shifter 140d is in a state of shifting the phase of the signal input to the second phase shifter 140d by +45 degrees as the phase shift amount, and the third phase shifter 150d is in a state of phase-shifting the signal input to the third phase shifter 150d by +α degrees as the phase shift amount, that is, in mode 3.

When the sixth DPDT switch 146 is in the twelfth state, one end of the first susceptance element 105 is connected to be short-circuited to the first radiation element 101 via the twenty-first terminal 146-1 and the twenty-third terminal 146-3. When the sixth DPDT switch 146 is in the twelfth state, the second phase shifter 140d is in a state of phase-shifting the signal input to the second phase shifter 140d by 0 degrees as the phase shift amount.

Further, when the sixth DPDT switch 146 is in the twelfth state and the seventh DPDT switch 156 is in the fourteenth state, the other end of the first susceptance element 105 is connected to the second radiation element 102 via the fourth transmission line 153 and the fifth transmission line 180. When the seventh DPDT switch 156 is in the fourteenth state, the third phase shifter 150d is in a state of phase-shifting the signal input to the third phase shifter 150d by +45+α degrees as the phase shift amount.

When the antenna device 100d is switched to a mode in which the sixth DPDT switch 146 is in the twelfth state and the seventh DPDT switch 156 is in the fourteenth state, the second phase shifter 140d and the third phase shifter 150d are in a mode in which the second phase shifter 140d is in a state of phase-shifting the signal input to the second phase shifter 140d by 0 degrees as the phase shift amount, and the third phase shifter 150d is in a state of phase-shifting the signal input to the third phase shifter 150d by +45+α degrees as the phase shift amount, that is, in mode 4.

As described above, in the antenna device 100d, it is possible to reduce a signal loss even when the distance between two radiation elements is narrow, while implementing the 4-branch diversity function with the two radiation elements by switching the mode of the second phase shifter 140d and the third phase shifter 150d.

Further, with such a configuration, in the antenna device 100d, it is possible to make the excitation amplitudes of the first radiation element 101 and the second radiation element 102 equal in amplitude while reducing the mutual coupling between the first radiation element 101 and the second radiation element 102 by the first susceptance element 105, the second susceptance element 106, the third susceptance element 107, and the fourth susceptance element 108, and therefore it is possible to adopt a simple configuration without using a directional coupler or the like.

Further, with such a configuration, the antenna device 100d can be made compact and have low loss.

Further, in the antenna device 100d, the total length of the fourth transmission line 153 and the fifth transmission line 180 can be made shorter by the phase shift amount of +45 degrees than the total length of the second transmission line 142, the third transmission line 152, and the fourth transmission line 153 of the antenna device 100c according to the fourth embodiment.

Further, since the antenna device 100d can be configured by two DPDT switches while the number of DPDT switches of the antenna device 100a according to the second embodiment is three, the number of DPDT switches can be reduced.

Further, since the antenna device 100d can be configured by two matching circuits while the number of matching circuits in the antenna device 100a according to the second embodiment is four, the number of matching circuits can be reduced.

Further, in the antenna device 100d, since the total of the phase shift amount from one end of the first susceptance element 105 to the first radiation element 101 and the phase shift amount from the other end of the first susceptance element 105 to the second radiation element 102 is equal between mode 3 and mode 4, it is not necessary to switch the fifth matching circuit 160 or the sixth matching circuit 170 in synchronization with the mode switching of the second phase shifter 140d and the third phase shifter 150d. The fifth matching circuit 160 or the sixth matching circuit 170 can reduce the reflection amplitude when power is supplied from the first input and output terminal 103 and the second input and output terminal 104 in both mode 3 and mode 4.

Note that, in the antenna device 100d, if when the second phase shifter 140d and the third phase shifter 150d are in mode 3, the phase shift amount from the other end of the first susceptance element 105 to the second radiation element 102 is larger by −45+α degrees than the phase shift amount from one end of the first susceptance element 105 to the first radiation element 101, and when the second phase shifter 140d and the third phase shifter 150d are in mode 4, if the phase shift amount from the other end of the first susceptance element 105 to the second radiation element 102 is larger by 45+α degrees than the phase shift amount from one end of the first susceptance element 105 to the first radiation element 101, for example, in the antenna device 100d, between one end of the first susceptance element 105 and the twenty-first terminal 146-1, between the twenty-third terminal 146-3 and the first radiation element 101, or between the twenty-eighth terminal 156-4 and the second radiation element 102 may be connected via a transmission line (not shown).

It should be noted that the present invention can freely combine the embodiments, modify any constituent element of each embodiment, or omit any constituent element in each embodiment within the scope of the invention.

### INDUSTRIAL APPLICABILITY

The antenna device according to the present invention can be applied to electronic communication equipment.

### REFERENCE SIGNS LIST

100, 100a, 100b, 100c, 100d: antenna device, 101: first radiation element, 102: second radiation element, 103: first input and output terminal, 104: second input and output terminal, 105: first susceptance element, 106: second susceptance element, 107: third susceptance element, 108: fourth susceptance element, 110, 110a: first phase shifter, 111: first DPDT switch, 111-1: first terminal, 111-2: second terminal, 111-3: third terminal, 111-4: fourth terminal, 112: first transmission line, 120, 120a: first variable matching circuit, 121: second DPDT switch, 121-1: fifth terminal, 121-2: sixth terminal, 121-3: seventh terminal, 121-4: eighth terminal, 122: first matching circuit, 123: second matching circuit, 130, 130a: second variable matching circuit, 131: third DPDT switch, 131-1: ninth terminal, 131-2: tenth terminal, 131-3: eleventh terminal, 131-4: twelfth terminal, 132: third matching circuit, 133: fourth matching circuit, 140, 140c, 140d: second phase shifter, 141: fourth DPDT switch, 141-1: thirteenth terminal, 141-2: fourteenth terminal, 141-3: fifteenth terminal, 141-4: sixteenth terminal, 142: second transmission line, 146: sixth DPDT switch, 146-1: twenty-first terminal, 146-2: twenty-second terminal, 146-3: twenty-third terminal, 146-4: twenty-fourth terminal, 150, 150c, 150d: third phase shifter, 151: fifth DPDT switch, 151-1: seventeenth terminal, 151-2: eighteenth terminal, 151-3: nineteenth terminal, 151-4: twentieth terminal, 152: third transmission line, 153: fourth transmission line, 156: seventh DPDT switch, 156-1: twenty-fifth terminal, 156-2: twenty-sixth terminal, 156-3: twenty-seventh terminal, 156-4: twenty-eighth terminal, 160: fifth matching circuit, 170: sixth matching circuit, 180: fifth transmission line, 201: inverted-F antenna, 202: inverted-F antenna, 211: ground conductor plate, 300: phase shift circuit, 301-1, 301-2, . . . , 301-N, 301-N+1: capacitor, 302-1, 302-1, . . . , 302-N: inductor, 303: ground conductor

1. An antenna device comprising:
a first radiation element;
a second radiation element;
a first input and output terminal;
a second input and output terminal;
a first phase shifter having a first end connected to the second radiation element;
a first susceptance element having a first end connected to the first radiation element and a second end connected to a second end of the first phase shifter;
a second susceptance element having a first end connected to a first end of the first susceptance element;
a third susceptance element having a first end connected to a second end of the first susceptance element;
a fourth susceptance element having a first end connected to a second end of the second susceptance element and a second end connected to a second end of the third susceptance element;
a first variable matching circuit having a first end connected to a first end of the fourth susceptance element and a second end connected to the first input and output terminal; and
a second variable matching circuit having a first end connected to a second end of the fourth susceptance element and a second end connected to the second input and output terminal, wherein
when power is supplied from the first input and output terminal or the second input and output terminal, each susceptance value of the first susceptance element, the second susceptance element, the third susceptance element, and the fourth susceptance element are set so that an excitation amplitude of the first radiation element and an excitation amplitude of the second radiation element have a substantially equal amplitude, and coupling between the first input and output terminal and the second input and output terminal is reduced.

2. The antenna device according to claim 1, wherein:
the first phase shifter has two states that are a state of phase-shifting a signal input to the first phase shifter by 0 degrees as a phase shift amount, and a state of phase-shifting a signal input to the first phase shifter by 90 degrees as a phase shift amount;
the first variable matching circuit has states individually corresponding to the two states of the first phase shifter, and in synchronization with switching of the first phase shifter to either state of the two states of the first phase shifter, the first variable matching circuit is switched to a state corresponding to a state after the first phase shifter is switched in the first variable matching circuit; and
the second variable matching circuit has states individually corresponding to the two states of the first phase shifter, and in synchronization with switching of the first phase shifter to either state of the two states of the first phase shifter, the second variable matching circuit is switched to a state corresponding to a state after the first phase shifter is switched in the second variable matching circuit.

3. The antenna device according to claim 1, wherein:
the first phase shifter is composed of a first DPDT switch and a first transmission line;
the first variable matching circuit is composed of a second DPDT switch, a first matching circuit, and a second matching circuit;
the second variable matching circuit is composed of a third DPDT switch, a third matching circuit, and a fourth matching circuit;
the first DPDT switch has a first terminal, a second terminal, a third terminal, and a fourth terminal;
the first DPDT switch has two states that are a first state in which the first terminal is connected to the third terminal and the second terminal is connected to the fourth terminal, and a second state in which the first terminal is connected to the fourth terminal and the second terminal is connected to the third terminal;
the second DPDT switch has a fifth terminal, a sixth terminal, a seventh terminal, and an eighth terminal;
the second DPDT switch has two states that are a third state in which the fifth terminal is connected to the seventh terminal and the sixth terminal is connected to the eighth terminal, and a fourth state in which the fifth terminal is connected to the eighth terminal and the sixth terminal is connected to the seventh terminal;
the third DPDT switch has a ninth terminal, a tenth terminal, an eleventh terminal, and a twelfth terminal;
the third DPDT switch has two states that are a fifth state in which the ninth terminal is connected to the eleventh terminal and the tenth terminal is connected to the twelfth terminal, and a sixth state in which the ninth terminal is connected to the twelfth terminal and the tenth terminal is connected to the eleventh terminal;
the first terminal is connected to a second end of the first susceptance element;
the second terminal is connected to a first end of the first transmission line;
the third terminal is connected to the second radiation element;
the fourth terminal is connected to a second end of the first transmission line;
the fifth terminal is connected to a first end of the second matching circuit;
the sixth terminal is connected to a first end of the first matching circuit;
the seventh terminal is connected to a first end of the fourth susceptance element;
the eighth terminal is connected to a second end of the first matching circuit;
the ninth terminal is connected to a first end of the fourth matching circuit;
the tenth terminal is connected to a first end of the third matching circuit;
the eleventh terminal is connected to a second end of the fourth susceptance element;
the twelfth terminal is connected to a second end of the third matching circuit;
a second end of the second matching circuit is connected to the first input and output terminal;
a second end of the fourth matching circuit is connected to the second input and output terminal; and
a mode in which the first DPDT switch is in the first state, the second DPDT switch is in the third state, and the third DPDT switch is in the fifth state, and a mode in which the first DPDT switch is in the second state, the second DPDT switch is in the fourth state, and the third DPDT switch is in the sixth state can be switched.

4. The antenna device according to claim 3, wherein
the first transmission line is composed of a phase shift circuit having lumped constant elements, and
a plurality of capacitors connected in parallel and inductors connected in series are alternately connected in the phase shift circuit.

5. An antenna device comprising:
a first radiation element;
a second radiation element;
a first input and output terminal;
a second input and output terminal;
a second phase shifter having a first end connected to the first radiation element;
a third phase shifter having a first end connected to the second radiation element;
a first susceptance element having a first end connected to a second end of the second phase shifter and a second end connected to a second end of the third phase shifter;
a second susceptance element having a first end connected to a first end of the first susceptance element;
a third susceptance element having a first end connected to a second end of the first susceptance element;
a fourth susceptance element having a first end connected to a second end of the second susceptance element and a second end connected to a second end of the third susceptance element;
a fifth matching circuit having a first end connected to a first end of the fourth susceptance element and a second end connected to the first input and output terminal; and
a sixth matching circuit having a first end connected to a second end of the fourth susceptance element and a second end connected to the second input and output terminal;
wherein
when power is supplied from the first input and output terminal or the second input and output terminal, each susceptance value of the first susceptance element, the second susceptance element, the third susceptance element, and the fourth susceptance element are set so that an excitation amplitude of the first radiation element and an excitation amplitude of the second radiation element have a substantially equal amplitude, and coupling between the first input and output terminal and the second input and output terminal is reduced.

6. The antenna device according to claim 5, wherein
the second phase shifter has two states that are a state of phase-shifting a signal input to the second phase shifter by 45 degrees as a phase shift amount, and a state of phase-shifting a signal input to the second phase shifter by 0 degrees as a phase shift amount,
the third phase shifter, with a set as any value of 0 or more and less than 360, has two states that are a state of phase-shifting a signal input to the third phase shifter by a degrees as a phase shift amount, and a state of phase-shifting a signal input to the third phase shifter by 45+α degrees as a phase shift amount, and
the third phase shifter, in synchronization with switching of the second phase shifter to a state of phase-shifting a signal input to the second phase shifter by 45 degrees as a phase shift amount, is switched to a state of phase-shifting a signal input to the third phase shifter by α degrees as a phase shift amount, and the second phase shifter, in synchronization with switching of the second phase shifter to a state of phase-shifting a signal input to the second phase shifter by 0 degrees as a phase shift amount, is switched to a state of phase-shifting a signal input to the third phase shifter by 45+α degrees as a phase shift amount.

7. The antenna device according to claim 5, wherein:
the second phase shifter is composed of a fourth DPDT switch and a second transmission line;
the third phase shifter is composed of a fifth DPDT switch, a third transmission line, and a fourth transmission line;
the fourth DPDT switch has a thirteenth terminal, a fourteenth terminal, a fifteenth terminal, and a sixteenth terminal;
the fourth DPDT switch has two states that are a seventh state in which the thirteenth terminal is connected to the sixteenth terminal and the fourteenth terminal is connected to the fifteenth terminal, and an eighth state in which the thirteenth terminal is connected to the fifteenth terminal and the fourteenth terminal is connected to the sixteenth terminal;
the fifth DPDT switch has a seventeenth terminal, an eighteenth terminal, a nineteenth terminal, and a twentieth terminal;
the fifth DPDT switch has two states that are a ninth state in which the seventeenth terminal is connected to the nineteenth terminal and the eighteenth terminal is connected to the twentieth terminal, and a tenth state in which the seventeenth terminal is connected to the twentieth terminal and the eighteenth terminal is connected to the nineteenth terminal;
the thirteenth terminal is connected to a first end of the first susceptance element;
the fourteenth terminal is connected to a first end of the second transmission line;
the fifteenth terminal is connected to the first radiation element;
the sixteenth terminal is connected to a second end of the second transmission line;
the seventeenth terminal is connected to a first end of the fourth transmission line;
the eighteenth terminal is connected to a first end of the third transmission line;
the nineteenth terminal is connected to the second radiation element;
the twentieth terminal is connected to a second end of the third transmission line;
a second end of the fourth transmission line is connected to a second end of the first susceptance element; and
a mode in which the fourth DPDT switch is in the seventh state and the fifth DPDT switch is in the ninth state, and a mode in which the fourth DPDT switch is in the eighth state and the fifth DPDT switch is in the tenth state can be switched.

8. The antenna device according to claim 7, wherein
the second transmission line, the third transmission line, or the fourth transmission line is composed of a phase shift circuit having lumped constant elements, and
a plurality of capacitors connected in parallel and inductors connected in series are alternately connected in the phase shift circuit.

9. The antenna device according to claim 5, wherein:
the second phase shifter is composed of a sixth DPDT switch and a fifth transmission line;
the third phase shifter is composed of a seventh DPDT switch, a fourth transmission line, and the fifth transmission line;
the sixth DPDT switch has a twenty-first terminal, a twenty-second terminal, a twenty-third terminal, and a twenty-fourth terminal;
the sixth DPDT switch has two states that are an eleventh state in which the twenty-first terminal is connected to the twenty-fourth terminal and the twenty-second terminal is connected to the twenty-third terminal, and a twelfth state in which the twenty-first terminal is connected to the twenty-third terminal and the twenty-second terminal is connected to the twenty-fourth terminal;
the seventh DPDT switch has a twenty-fifth terminal, a twenty-sixth terminal, a twenty-seventh terminal, and a twenty-eighth terminal;
the seventh DPDT switch has two states that are a thirteenth state in which the twenty-fifth terminal is connected to the twenty-seventh terminal and the twenty-sixth terminal is connected to the twenty-eighth terminal, and a fourteenth state in which the twenty-fifth terminal is connected to the twenty-eighth terminal and the twenty-sixth terminal is connected to the twenty-seventh terminal;
the twenty-first terminal is connected to a first end of the first susceptance element;
the twenty-second terminal is connected to a first end of the fifth transmission line;
the twenty-third terminal is connected to the first radiation element;
the twenty-fourth terminal is connected to the twenty-sixth terminal;
the twenty-fifth terminal is connected to a first end of the fourth transmission line;
the twenty-seventh terminal is connected to the second radiation element;
the twenty-eighth terminal is connected to a second end of the fifth transmission line;
a second end of the fourth transmission line is connected to a second end of the first susceptance element; and
a mode in which the sixth DPDT switch is in the eleventh state and the seventh DPDT switch is in the thirteenth state, and a mode in which the sixth DPDT switch is in the twelfth state and the seventh DPDT switch is in the fourteenth state can be switched.

10. The antenna device according to claim 9, wherein
the fourth transmission line or the fifth transmission line is composed of a phase shift circuit having lumped constant elements, and
a plurality of capacitors connected in parallel and inductors connected in series are alternately connected in the phase shift circuit.

11. The antenna device according to claim 1, wherein a susceptance value B₁ of the first susceptance element is determined so as to satisfy Equation (1),
B₁=±1/Z₀ EQUATION (1)
where Z₀ is a normalized impedance.

12. The antenna device according to claim 1, wherein
a susceptance value B₁ of the first susceptance element is determined so as to satisfy Equation (1), and
a susceptance value B₂ of the second susceptance element and the third susceptance element in which susceptance values are set to be equal and a susceptance value B₃ of the fourth susceptance element are determined so as to satisfy all of Equations (2) to (6),
$$\begin{matrix} {B}_{1} = \pm 1 \text{/} {Z}_{0} & EQUATION ( 1 ) \\ {Y}_{b} = ( \begin{matrix}{y}_{b 11} {y}_{b 12} \\ {y}_{b 21} {y}_{b 22}\end{matrix} ) = ( \begin{matrix}{{g}_{b}}_{11} + j {b}_{b 11} & {{g}_{b}}_{12} + j {b}_{b 12} \\ {g}_{b 21} + j {b}_{b 21} & {g}_{b 22} + j {b}_{b 22}\end{matrix} ) & EQUATION ( 2 ) \\ {B}_{2} = ( - {c}_{1} \pm \sqrt{{c}_{1}^{2} - 4 {g}_{b 12} {c}_{2}} ) / ( 2 {g}_{b 12} ) & EQUATION ( 3 ) \\ {B}_{3} = \frac{{B}_{2}^{2} {g}_{b 12}}{{b}_{b 11} {g}_{b 22} + {g}_{b 11} {b}_{b 22} - {g}_{b 12} {b}_{b 21} - {b}_{b 12} {g}_{b 21} + {B}_{2} ( {g}_{b 11} + {g}_{b 22} )} & EQUATION ( 4 ) \\ {c}_{1} = {g}_{b 12} ( {b}_{b 11} + {b}_{b 22} ) - {b}_{b 12} ( {g}_{b 11} + {g}_{b 22} ) & EQUATION ( 5 ) \\ {c}_{2} = - {g}_{b 12} ( {g}_{b 11} {g}_{b 22} - {b}_{b 11} {{b}_{b}}_{22} - {g}_{b 12} {g}_{b 21} ) + {b}_{b 12} ( - {b}_{b 11} {g}_{b 22} - {g}_{b 11} {b}_{b 22} + {b}_{b 12} {g}_{b 21} ) & EQUATION ( 6 )\end{matrix}$$
where the double sign corresponds to those of Equations (1) and (3) in the same order,
further, Z₀ is the normalized impedance, and
further, Y_{b} is an admittance matrix when the first radiation element side and the second radiation element side are viewed from one end of the second susceptance element on the first radiation element side and one end of the third susceptance element on the second radiation element side.
